(19) United States
(12) Patent Application Publication
(10) Pub. No.: US 2026/0290308 A1
(43) Pub. Date: Sep. 24, 2026

(54) SYSTEM

(71) Applicant: SoftBank Group Corp., Tokyo (JP)

(72) Inventor: Masaru YAHIRO, Tokyo (JP)

(73) Assignee: SoftBank Group Corp., Tokyo (JP)

(21) Appl. No.: 19/567,013

(22) Filed: Mar. 14, 2026

(30) Foreign Application Priority Data
Mar. 19, 2025 (JP) 2025-045142

(51) Int. Cl. G10L 13/027; G06F 40/166; G06F 40/58; G10L 13/033; G10L 13/08; G10L 13/10

(52) U.S. Cl. CPC G10L 13/027; G06F 40/166; G06F 40/58; G10L 13/033; G10L 13/086; G10L 13/10

(57) ABSTRACT

A system includes a processor that is configured to receive a delivery time, a theme, and an emotion specified by a user, generate a prompt for instructing a generative AI model to generate audio content based on the received delivery time, theme, and emotion, cause the generative AI model to generate the audio content using the prompt, and convert the generated audio content into audio data by using a speech synthesis technique and provide the audio data to the user.

### CROSS-REFERENCE TO RELATED APPLICATION

This application is based on and claims priority under 35 USC 119 from Japanese Patent Application No. 2025-045142 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating audio content typically require human creators to manually plan a program structure, gather topic-specific information, and record or edit the audio. Even with the introduction of generative AI models and text-to-speech technologies, existing solutions often do not provide an integrated mechanism that automatically generates audio content tailored to a user-specified delivery time, theme, and desired emotion. As a result, it is difficult for users to instantly obtain personalized audio programs, such as radio-style content, that match both the user's interests and the user's available listening time. Furthermore, conventional systems do not adequately control the length of the generated audio content based on a specified delivery time, nor do they sufficiently utilize external information sources, such as the Internet or databases, to enrich the content in a manner consistent with the requested theme and emotion. Therefore, there is a need for a system capable of automatically generating and providing audio data that is dynamically customized according to a user-specified delivery time, theme, and emotion, while effectively controlling the length of the audio content and improving its relevance and expressiveness.

### SUMMARY

To solve the above problems, according to one aspect of the present invention, there is provided a system comprising a processor, wherein the processor is configured to receive a delivery time, a theme, and an emotion specified by a user, generate a prompt for instructing a generative AI model to generate audio content based on the received delivery time, theme, and emotion, cause the generative AI model to generate the audio content using the prompt, and convert the generated audio content into audio data by using a speech synthesis technique and provide the audio data to the user. In another aspect, the processor is configured to collect information relevant to the theme and the emotion from the Internet or from one or more databases, generate the prompt based on the collected information, and cause the generative AI model to generate the audio content based on the prompt, thereby enriching the content with up-to-date and contextually appropriate information. In still another aspect, the processor is configured to generate, based on the delivery time, a prompt for instructing the generative AI model to generate the audio content in consideration of the delivery time so as to adjust a length of the audio content, and to control the length of the audio content by using the prompt, thereby enabling automatic generation of audio programs that substantially match the user-specified delivery time while reflecting the requested theme and emotion.

The term “processor” refers to any hardware component or combination of hardware components, such as a central processing unit (CPU), a graphics processing unit (GPU), a digital signal processor (DSP), or a dedicated logic circuit, that executes instructions to perform the functions described in the present specification and claims.

The term “delivery time” refers to a length of time specified by a user, typically expressed in units such as minutes or seconds, that indicates a target duration for audio content to be generated and delivered.

The term “theme” refers to a subject, topic, or category of content specified by a user, such as health information, news, or technology, which serves as a basis for determining the content to be generated by the system.

The term “emotion” refers to a desired emotional tone or mood, such as joyful, calm, serious, or exciting, specified by a user and reflected in the style, expression, or atmosphere of the generated audio content.

The term “prompt” refers to data, including text or structured instructions, generated by the processor for input to a generative AI model, the data specifying conditions or guidelines, such as the delivery time, theme, and emotion, for generating audio content.

The term “generative AI model” refers to a machine learning model, such as a neural network trained on large-scale data, that is capable of generating content, including text-based scripts or other representations of audio content, in response to a received prompt.

The term “audio content” refers to information intended to be presented in audio form, including but not limited to narrated speech, announcements, commentary, or radio-style programs, which is generated in an intermediate digital representation before conversion to audio data.

The term “audio data” refers to digital data representing sound, such as waveform data or encoded audio files, that can be output through an audio playback device so that a user can listen to the generated content.

The term “speech synthesis technique” refers to any method or technology, including text-to-speech (TTS) processing, for converting text or another intermediate representation of content into synthetic speech audio data.

The term “Internet” refers to a global network of interconnected computer networks that use standardized communication protocols to exchange data and that provide access to online resources, such as web pages, APIs, and online databases.

The term “database” refers to an organized collection of data, stored in a computer-readable medium and accessible by the processor, from which information related to a theme or an emotion can be retrieved for use in generating prompts and audio content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

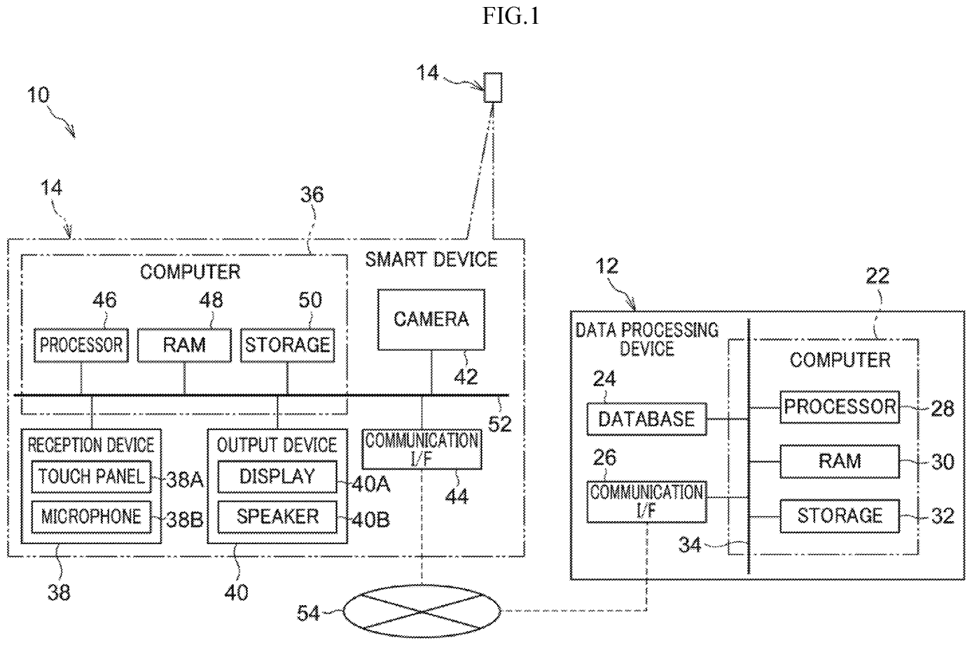

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

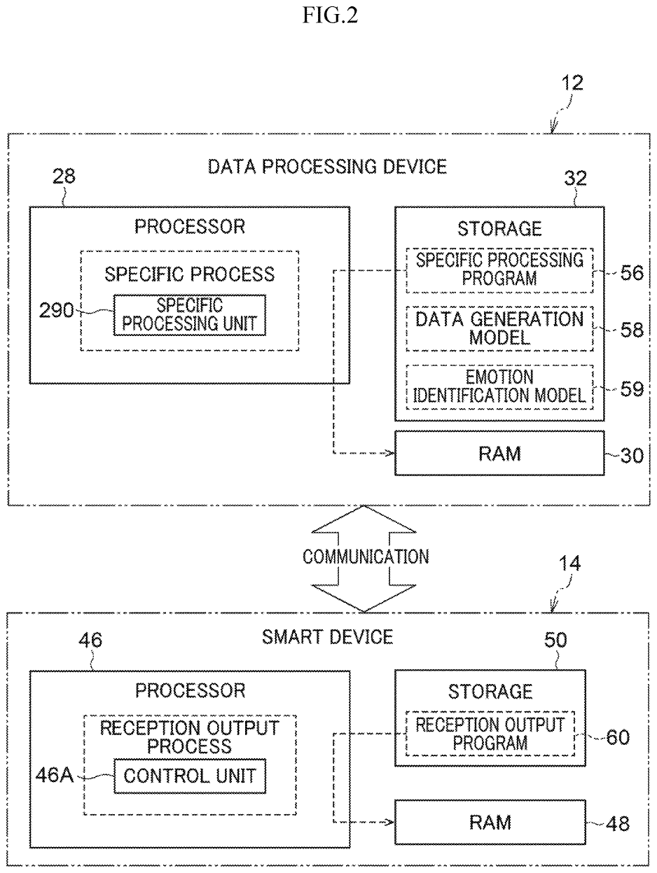

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for generating audio programs based on user preferences typically rely on static templates or manually authored scripts, and therefore cannot flexibly adapt the content structure and duration to arbitrary user-specified delivery times and themes. Even when a generative AI model is used to create content, known implementations generally treat the model as a black-box text generator and fail to integrate precise control over playback time, program structure, and streaming delivery in a coordinated manner. As a result, the generated audio content often does not match the requested length, exhibits inconsistent structuring of segments, or requires manual post-editing before being suitable for streaming distribution. This leads to inefficient use of computational resources, increased latency in content delivery, and degraded user experience.

Furthermore, conventional content generation pipelines typically separate prompt construction, model invocation, length adjustment, and text-to-speech processing into loosely coupled components without explicit feedback control based on playback-time estimation. In such architectures, the system cannot automatically and reliably adjust the amount of generated text to conform to a target delivery time, and cannot dynamically refine the prompt or content in response to duration mismatches. This limitation results in excess or insufficient content, unnecessary repeated model invocations, and suboptimal utilization of network and processing resources during streaming.

Additionally, existing systems do not provide a standardized mechanism to encode, within a prompt sentence, explicit information about program format, such as introduction parts, multiple segment parts, and closing parts, together with tone and configuration information. Without such structured prompt design, the generative AI model may produce content that lacks coherent segmentation or fails to satisfy user expectations for program-like audio, thereby reducing the technical effectiveness of generative AI in automated audio program generation.

Accordingly, there is a need for an improved computer-implemented system and method that tightly integrates structured prompt generation, generative AI model control, duration-aware text adjustment, and speech synthesis with streaming output. Such a system should algorithmically estimate playback time from generated text, automatically increase or decrease the content amount through additional prompts and summarization or deletion, and output audio data in a streaming format, thereby improving the efficiency, reliability, and quality of AI-generated audio program delivery from a computer technology standpoint.

The specific processing by the specific processing unit 290 of the data processing device 12 in Example 1 is realized by the following means.

The present invention provides a server comprising a processor configured to receive delivery time information and theme information from a user terminal; generate, based on the delivery time information and the theme information, a prompt sentence including a program structure corresponding to the delivery time information and a content structure corresponding to the theme information; input the prompt sentence to a generative artificial intelligence model, instruct the generative artificial intelligence model to generate program text information based on the prompt sentence, and acquire the program text information output from the generative artificial intelligence model; calculate a playback time for the program text information based on an assumed speech rate, compare the playback time with the delivery time information, and adjust an amount of the program text information so that the playback time matches or approximates the delivery time information, the adjustment including generating an additional input prompt sentence to cause the generative artificial intelligence model to generate additional text information when the program text information is insufficient relative to the delivery time information and performing partial deletion or summarization of the program text information when the program text information is excessive relative to the delivery time information; and input adjusted program text information to a speech synthesis processing unit, instruct the speech synthesis processing unit to generate audio data corresponding to the adjusted program text information, convert the audio data into a streaming delivery format, and provide the audio data in the streaming delivery format to the user terminal. This enables a computer-implemented content generation and distribution pipeline that automatically produces AI-generated audio programs with controlled duration and structured format, reduces manual intervention and wasted computation, and improves the technical performance of audio streaming services by delivering content that reliably conforms to user-specified delivery times and themes.

The term “delivery time information” refers to information indicating a target duration for playback of an audio program as specified by a user, including for example a length expressed in units of time such as minutes or seconds.

The term “theme information” refers to information indicating a subject matter, topic, or content category of an audio program as specified by a user, including for example textual data describing a genre, field, or focus of the program.

The term “user terminal” refers to an information processing apparatus operated by a user and configured to transmit and receive data over a communication network, including for example a portable terminal, a stationary terminal, a communication terminal, or a display device.

The term “prompt sentence” refers to control information in a natural language or structured language format provided as input to a generative artificial intelligence model, the control information specifying at least a requested program structure, content structure, or style of generated text.

The term “program structure” refers to information defining an arrangement of sections or parts of an audio program, including for example an introduction part, one or more segment parts, and a closing part.

The term “content structure” refers to information defining an internal organization of content within an audio program, including for example ordering of topics, division into subsections, and relationships among elements corresponding to a theme.

The term “generative artificial intelligence model” refers to a trained computational model configured to generate text or other data based on input prompt information, the trained computational model including for example a machine learning model, a neural network model, or a statistical language model.

The term “program text information” refers to textual data generated by a generative artificial intelligence model in response to a prompt sentence, the textual data representing content intended to be presented as an audio program.

The term “assumed speech rate” refers to a parameter indicating a representative speed of speech used for estimating playback time of program text information, including for example a number of words or characters per unit time.

The term “playback time” refers to an estimated or actual time required to present program text information as audible speech, calculated for example based on an assumed speech rate and an amount of text.

The term “amount of the program text information” refers to a quantity or volume measure of program text information, including for example a number of words, a number of characters, a number of sentences, or a length corresponding to an estimated playback time.

The term “additional input prompt sentence” refers to a prompt sentence generated after an initial prompt sentence and provided to a generative artificial intelligence model in order to obtain additional text information or modified text information.

The term “additional text information” refers to text generated by a generative artificial intelligence model in response to an additional input prompt sentence, the text being used to supplement existing program text information.

The term “partial deletion” refers to processing that removes a part of program text information according to a predetermined rule or condition, thereby reducing an amount of the program text information.

The term “summarization” refers to processing that compresses or condenses program text information while preserving main meaning or key points, thereby reducing an amount of the program text information.

The term “speech synthesis processing unit” refers to a functional unit implemented by hardware, software, or a combination thereof, configured to convert text data into audio data representing synthetic speech.

The term “audio data” refers to digital data representing sound waves, including for example encoded or compressed data in a format suitable for playback as audible sound.

The term “streaming delivery format” refers to a data format and transfer method configured to sequentially transmit portions of audio data over a network for real-time or near real-time playback, including for example formats based on segmented media files and associated playlist information.

The term “template information” refers to predefined data structures, patterns, or text fragments used as a basis for generating a prompt sentence, the predefined data structures including for example tone information, configuration information, and program format indications.

The term “tone information” refers to information specifying a style or manner of expression of generated content, including for example indications of formality level, emotional nuance, or target audience suitability.

The term “configuration information of a program” refers to information defining a layout, ordering, or combination of parts of a program, including for example a specification that a program includes an introduction part, a plurality of segment parts, and a closing part.

In one embodiment, a server cooperates with one or more terminals to realize a system that generates, adjusts, and streams audio programs based on user-specified delivery time information and theme information. The server includes at least one processor, a memory, a storage device, a network interface, and access to a speech synthesis processing unit. The terminal includes at least one processor, a memory, a display device, an audio output device, and a network interface. The user operates the terminal to specify parameters for a desired audio program and to consume the streamed audio output.

The server executes application software on a general-purpose operating system, such as a UNIX-like operating system or a commercial operating system, and provides an application programming interface accessible over a communication network. The terminal executes a web browser or a native application that issues requests to the server using a network protocol such as HTTPS over TCP/IP. The user operates an input interface of the terminal, such as a touch panel or a pointing device, to input delivery time information and theme information. The terminal displays input fields and sends the entered information to the server as structured data over the network.

The server stores the received delivery time information and theme information in the memory as internal data structures, for example, as records including fields for time duration and text describing a theme. The server then generates a prompt sentence for a generative AI model. The server stores a plurality of template data structures in the storage device; each template data structure includes text fragments describing program format, tone, and segment configuration. The server selects and combines suitable template data structures with the delivery time information and the theme information to construct a prompt sentence that explicitly encodes an introduction part, a plurality of segment parts, and a closing part.

The server, for example, generates a prompt sentence such as:
“Please create a 30-minute radio show about health-related information, structured with an introduction, several main segments, and a closing summary, using an informative but friendly tone suitable for a general audience.”

The server, in another example, generates a prompt sentence such as:
“Please create a 15-minute radio show about the latest technology trends, including AI, smartphones, and cloud computing, with an introduction, multiple topic segments, and a closing recap, in clear and engaging language.”

The server further refines the prompt sentence by encoding control instructions that are not normally used in human-authored scripts. The server embeds meta-instructions such as explicit target word counts, segment-level constraints, and pacing guidance into the prompt sentence. For example, the server appends to the prompt sentence text such as:
“Ensure that the total script length corresponds to approximately 15 minutes of spoken content at a moderate speaking speed, and distribute the time evenly across three segments.”

The server provides the prompt sentence to a generative AI model. The server, in one embodiment, accesses a transformer-based neural network model deployed on a remote computing resource. The generative AI model includes an input embedding layer, a plurality of self-attention layers, and an output projection layer. The server configures model parameters such as temperature, maximum token length, and decoding strategy (for example, beam search or nucleus sampling). The server sends the prompt sentence to the generative AI model through an application programming interface.

The generative AI model internally represents the prompt sentence as a sequence of tokens, applies positional encodings, and processes the tokens through stacked attention blocks that perform matrix multiplications, non-linear activations, and normalization operations. The model has been trained in advance using a corpus of text data including scripted content, narrative structures, and dialog. The model's weights are optimized during a training phase by minimizing a loss function such as cross-entropy loss between predicted tokens and ground truth tokens, using a gradient-based optimization method. The server does not perform the training phase during normal operation, but the server uses the trained weights to perform inference when generating program text information.

The server receives the generated tokens from the generative AI model and reconstructs them into program text information. The server stores the program text information in the memory as a structured text object, for example, including markers for introduction, each segment, and closing. The server then applies an algorithm to estimate a playback time for the program text information. The server computes the number of words or characters in the text, divides the number by an assumed speech rate parameter, and thereby obtains an estimated playback time. The server compares the estimated playback time with the delivery time information.

When the estimated playback time is shorter than the delivery time information by more than a predetermined threshold, the server determines that additional content is required. The server then creates an additional input prompt sentence based on the existing program text information. For example, the server generates an additional input prompt sentence such as:
“The current script is shorter than 30 minutes. Please add one more detailed segment with practical examples and anecdotes on health-related information to extend the duration by about 7 minutes, keeping the same tone and structure.”

The server provides the additional input prompt sentence and, in some embodiments, a summary of the existing segments to the generative AI model. The generative AI model then generates additional text, which the server merges into the program text information as an additional segment or as expanded content in existing segments. The server re-estimates the playback time based on the updated program text information and repeats this control loop until the estimated playback time matches or approximates the delivery time information within the threshold. This feedback loop constitutes a non-conventional control mechanism that uses model output duration as a technical parameter to adjust further model input.

When the estimated playback time is longer than the delivery time information by more than a predetermined threshold, the server applies a reduction algorithm. The server identifies low-priority portions of the program text information, for example, based on section markers, repeated content, or length of individual segments. The server deletes selected sentences or paragraphs or generates, via a summarization prompt sentence, a compressed version of specific segments. The server, in such an embodiment, generates a prompt sentence such as:
“Summarize the following segment so that it can be spoken in about 3 minutes while preserving the main points and examples.”

The server replaces the original segment text with the summarized text, decreases the amount of program text information, and re-estimates the playback time. By performing such iterative deletion and summarization, the server controls overall duration in a deterministic, algorithmic manner that goes beyond simple human-like editing.

The server uses this time-control mechanism to obtain program text information whose estimated playback time closely matches the delivery time information. This algorithmic control improves computational efficiency because the server reduces unnecessary regeneration of entire scripts and limits the number of generative model calls to targeted expansions or reductions. The server thereby lowers processing time and network usage between the server and the model host, which improves throughput for multiple concurrent users.

The server passes the adjusted program text information to the speech synthesis processing unit. In one embodiment, the speech synthesis processing unit includes a text analysis module, a prosody prediction module, and a waveform generation module, implemented by a neural network-based text-to-speech engine. The speech synthesis processing unit converts the text into phoneme sequences, predicts prosodic features such as pitch and duration using a trained model, and generates corresponding audio waveforms using a neural vocoder network. The neural vocoder network has been trained using supervised learning, where an error function such as mean squared error or a spectral distance metric is minimized between predicted waveforms and recorded speech waveforms.

The server receives audio data from the speech synthesis processing unit as a digital stream encoded in an audio format such as an adaptive streaming format or a compressed audio format. The server stores the audio data in the storage device and segments the audio data into chunks for streaming. The server generates playlist information that indexes the chunks and prepares the audio data for streaming delivery.

The terminal receives a streaming URL and requests the playlist and audio chunks from the server. The terminal buffers the received audio data in the memory and decodes the compressed audio using the terminal's audio codec. The terminal outputs the decoded audio through the audio output device. The user listens to the program on the terminal, and the user experiences an audio program whose duration and structure have been automatically controlled to match the initial request.

The server improves computer technology by performing duration-aware control of generative AI output at the system level. The server uses specific data structures (for example, prompt templates with explicit segment markers and duration parameters), quantitative estimations (for example, word counts and assumed speech rate), and feedback-based generation and summarization loops to minimize mismatch between requested and actual playback time. This approach reduces repeated full-generation tasks and avoids naive trial-and-error prompting, thereby decreasing processing time and resource usage in the server and in the generative AI model infrastructure.

The server also improves data management by structuring generated content into program segments and by storing metadata such as estimated playback time, number of segments, and assigned theme. This structure enables the server to selectively modify segments without reprocessing the entire program, leading to more efficient memory usage and reduced data transfer when adjustments are needed.

The terminal, by relying on a streaming delivery format generated by the server, uses a smaller initial buffer and receives smaller incremental segments, which reduces perceived start-up delay and lowers bandwidth spikes on the network. This configuration reduces communication load and improves quality of service for multiple concurrent streaming sessions.

The system provides technical advantages over manual scripting or static template-based approaches, because the generative AI model, under server control, follows non-human, algorithmically enforced constraints derived from delivery time and structure parameters. The server uses rules for additional prompt generation, segment-level summarization, and time-estimation that are specifically designed for machine processing and that would not naturally arise from human editing practices. As a result, the server achieves higher accuracy in matching requested durations, lower error rates in structural completeness (for example, ensuring that introduction and closing parts are always present), and faster overall processing time per request.

In another embodiment, the server uses alternative generative AI models, such as encoder-decoder architectures or recurrent neural networks, provided that the server still constructs prompt sentences that contain explicit program structure and duration constraints and still applies the same duration-aware feedback control. In a further embodiment, the server adjusts the assumed speech rate dynamically based on user preferences or detected playback speed, which further refines the playback time estimation and ensures precise alignment with the requested delivery time.

In yet another embodiment, the server maintains a history of previous programs and uses historical data statistics to initialize parameters of the assumed speech rate or to choose suitable template structures for specific themes. The server, by exploiting these statistics, reduces the number of iterations required to converge to a desired playback time, thereby further improving computational efficiency and responsiveness.

In all these embodiments, the server, the terminal, and the generative AI model cooperate to provide an integrated, technically grounded pipeline for generating, controlling, and streaming audio programs. The pipeline is not limited to abstract manipulation of text but is closely tied to actual audio generation, streaming protocols, and device playback behavior, and thus provides a concrete improvement in computer-based audio content delivery.

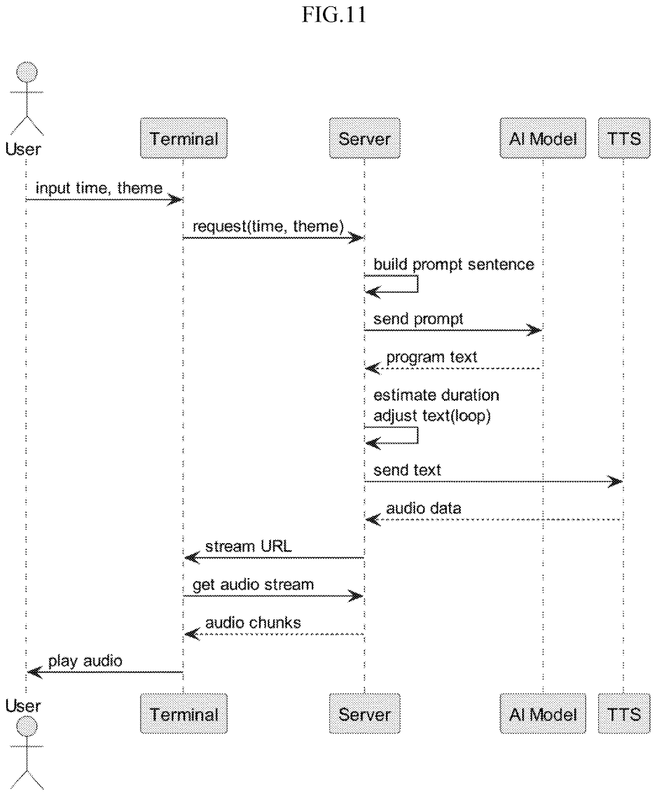

The following describes the processing flow using FIG. 11.

### Step 1:

The user operates the terminal to launch an application and input request parameters.

The terminal displays an input screen with fields for delivery time information and theme information.

The user inputs, as an example, “30 minutes” as delivery time information and “health-related information” as theme information.

The terminal takes, as input, the user's keystrokes and touch operations, converts them into internal text strings, and stores them in memory as delivery time information and theme information.

The terminal performs basic validation, such as checking that the delivery time information is a positive value and that the theme information is not empty.

The terminal generates, as output, a structured request containing at least the delivery time information and the theme information, and transmits this structured request to the server via a network interface using a communication protocol.

### Step 2:

The server receives the request from the terminal and parses the included parameters.

The server takes, as input, the structured request data received over the network, including the delivery time information and the theme information.

The server decodes the request, extracts the delivery time information and the theme information, and stores them as internal variables or records in memory.

The server performs validation processing, such as verifying that the delivery time information falls within an allowed range and that the theme information length does not exceed a configured limit.

The server generates, as output, normalized delivery time information (for example, a numeric duration value in minutes) and a cleaned theme text string for use in subsequent processing.

### Step 3:

The server constructs a prompt sentence based on the delivery time information and the theme information.

The server takes, as input, the normalized delivery time information and the cleaned theme text string, together with template information stored in a storage device.

The server selects a template that includes placeholders for duration, theme, tone, and segment structure, and performs string substitution to insert the delivery time information and the theme information into the placeholders.

The server appends explicit instructions about program structure, such as an introduction, multiple segment parts, and a closing part, and optional tone information such as “informative but friendly.”

The server generates, as output, a prompt sentence text, for example: “Please create a 30-minute radio show about health-related information, structured with an introduction, several main segments, and a closing summary, using an informative but friendly tone suitable for a general audience.”

### Step 4:

The server sends the prompt sentence to a generative AI model and obtains program text information.

The server takes, as input, the prompt sentence text and configuration parameters such as maximum token count and sampling temperature.

The server transmits the prompt sentence to the generative AI model via an interface and receives a sequence of tokens representing generated text.

The generative AI model internally processes the prompt sentence using a neural network that applies token embedding, positional encoding, multi-head self-attention, and feed-forward layers, and outputs token probabilities step by step.

The server concatenates the received tokens, decodes them into a character sequence, and forms structured program text information, including, for example, paragraphs corresponding to an introduction, several segments, and a closing.

The server generates, as output, the complete program text information that is intended to be used as the script of the audio program.

### Step 5:

The server estimates playback time of the program text information.

The server takes, as input, the program text information and a stored assumed speech rate parameter, such as a number of words per minute.

The server counts the number of words or characters in the program text information using a text-processing routine.

The server divides the counted number by the assumed speech rate to compute an estimated playback time.

The server compares the estimated playback time with the delivery time information and calculates a difference value.

The server generates, as output, the estimated playback time and the difference between the estimated playback time and the requested delivery time information.

### Step 6:

The server determines whether additional content or reduction is required and adjusts the amount of program text information.

The server takes, as input, the estimated playback time, the requested delivery time information, and the program text information.

The server evaluates whether the playback time is shorter than, approximately equal to, or longer than the delivery time information by comparing the difference value with predefined thresholds.

When the playback time is shorter, the server generates an additional input prompt sentence, for example: “The current script is shorter than 30 minutes. Please add one more detailed segment with practical examples on health-related information to extend the duration by about 7 minutes, keeping the same tone and structure.”

The server sends this additional input prompt sentence, optionally with a summary of existing segments, to the generative AI model, receives additional text, and merges the additional text into the program text information.

When the playback time is longer, the server identifies low-priority sections based on structural markers or heuristics, and either deletes selected sentences or invokes the generative AI model with a summarization prompt sentence to compress specific segments.

The server updates the program text information and recomputes the estimated playback time, repeating this process until the playback time matches or approximates the delivery time information within a threshold.

The server generates, as output, adjusted program text information whose estimated playback time is controlled to be near the requested delivery time.

### Step 7:

The server converts the adjusted program text information into audio data using a speech synthesis processing unit.

The server takes, as input, the adjusted program text information and synthesis parameters such as language, voice type, and speaking style.

The server provides the adjusted program text information to the speech synthesis processing unit, which performs text analysis, phonetic conversion, prosody prediction, and waveform generation using a trained neural network.

The server receives a digital audio stream or file representing speech corresponding to the adjusted program text information.

The server may encode or re-encode the audio into a desired compression format, and store the resulting audio data in a storage device.

The server generates, as output, audio data suitable for streaming, associated with metadata such as duration and encoding format.

### Step 8:

The server prepares the audio data for streaming delivery.

The server takes, as input, the audio data and configuration parameters for streaming, such as segment length and playlist format.

The server segments the audio data into multiple smaller chunks using media-processing operations and creates a playlist file that lists the chunk files in playback order.

The server stores the chunk files and playlist file at locations accessible via the network interface and constructs a streaming URL that identifies the playlist file.

The server generates, as output, the streaming URL and optionally streaming metadata, and transmits them to the terminal in a response message.

### Step 9:

The terminal receives the streaming URL and plays back the audio data for the user.

The terminal takes, as input, the response message from the server, extracts the streaming URL, and configures a media player module with the streaming URL.

The terminal requests the playlist file and subsequent audio chunks from the server over the network, buffers received chunks in memory, and decodes the audio using built-in codecs.

The terminal outputs the decoded audio through the audio output device, such as speakers or headphones, under control of the media player module.

The user listens to the generated audio program, and the terminal provides playback controls such as play, pause, and stop.

The terminal generates, as output, audible sound corresponding to the audio program that is temporally aligned with the requested delivery time and thematically aligned with the theme specified by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content delivery systems mainly distribute pre-produced, static audio files. In such systems, a server simply retrieves an existing file from storage and transmits it to a terminal, without dynamically adjusting the content to user-specified temporal constraints or topics. As a result, the server does not control the length of the audio content based on a user-specified delivery time, and the user often receives content that is either too short or too long for a particular listening context, such as a commute or a workout session.

Moreover, when generative AI models are employed in a naive manner, a server typically sends to the model only a simple topic description, and passively accepts whatever length of text is returned. In this configuration, the server does not compute or provide any explicit target length parameter to the generative AI model and does not perform any iterative adjustment based on the generated output. Consequently, there is no effective mechanism for the computing system to control resource usage, such as API computation time and network bandwidth, or to guarantee that the generated audio content approximates a desired playback duration. This leads to inefficient use of computing resources and an inconsistent user experience.

Further, many systems treat text generation and speech synthesis as independent processes. A conventional server does not manage unified metadata linking generated text information, converted audio data, and user delivery parameters (such as delivery time and theme). Without such integrated management, it is difficult for the computer system to support repeated playback, adaptive refinement of content, and lifecycle management of generated assets. This lack of coordination between generative AI processing, speech synthesis, and content delivery limits the scalability and controllability of the overall computing architecture.

Accordingly, there is a need for improved computer technology in which a processor on a server coordinates the acquisition of user input, the generation of prompt sentences tailored to delivery-time constraints, the control of a generative AI model based on explicit length targets, and the storage and delivery of synthesized audio data, such that the system can dynamically produce personalized audio content whose playback duration is actively controlled by the computer system itself.

The specific processing by the specific processing unit 290 of the data processing device 12 in Application Example 1 is realized by the following means.

The present invention provides a server comprising a processor configured to receive, from a terminal, information including a delivery time and a theme, to calculate a target length for audio output based on the delivery time, to generate a prompt sentence by combining the theme and the target length, and to input the prompt sentence to a generative AI model so as to cause the generative AI model to generate text information for audio content, the processor further configured to input the text information for the audio content to a speech synthesis unit so as to convert the text information into audio data, to store the audio data in a storage unit, to provide the audio data to the terminal in a format enabling streaming or downloading, to store identification information and delivery management information related to the text information for the audio content and the audio data in a memory unit, and, in response to a playback instruction from the terminal, to read out the audio data from the storage unit and transmit the audio data to the terminal, and optionally configured to estimate, based on the delivery time and the theme, a number of words or tokens required for the audio output and to incorporate the estimate into the prompt sentence, and to iteratively adjust the text information by supplying additional prompt sentences to the generative AI model when a length of the generated text information deviates from the target length. This enables the computer system to algorithmically control generation length and playback duration of dynamically produced audio content, to improve utilization of computational and network resources, and to provide users with personalized audio content whose characteristics, including timing and topic, are more closely aligned with user-specified constraints.

The term “processor” refers to a hardware or virtual information processing unit, such as a central processing unit or a computing core, that executes instructions to perform logical operations, numerical calculations, control flows, and data processing required to implement functions of the system.

The term “terminal” refers to an information processing apparatus operated by a user, such as a mobile communication device, a portable computing device, or a client computer, that is configured to transmit input information to a server and to receive and reproduce audio data.

The term “delivery time” refers to a time-related parameter designated by a user, indicating a desired playback duration for audio content that is to be generated and provided by the system.

The term “theme” refers to subject matter information, such as a topic, field, or category, specified by a user and used as a basis for determining semantic content of text information and corresponding audio content.

The term “target length” refers to a quantitative value representing a desired amount of content, such as a number of words, a number of tokens, or an equivalent measure, calculated by the processor on the basis of the delivery time and optionally other conditions, and used to control generation of text information.

The term “prompt sentence” refers to a text string or a set of text strings, including instructions, constraints, and descriptive information, generated by the processor and supplied as input to a generative AI model to cause the generative AI model to generate text information for audio content.

The term “generative AI model” refers to a machine learning model, such as a neural network —based language model or sequence generation model, that receives a prompt sentence as input and outputs generated text information according to statistical patterns learned from training data.

The term “text information for audio content” refers to character data, such as sentences, paragraphs, or scripts, produced by the generative AI model or processed by the processor, which is intended to be converted into audio data by speech synthesis.

The term “speech synthesis unit” refers to a hardware or software component, such as a text-to-speech engine, that analyzes text information and generates corresponding audio data by applying linguistic processing and acoustic modeling.

The term “audio data” refers to digital data representing sound, such as sampled waveform data or encoded audio bitstreams, that are output from the speech synthesis unit and are suitable for storage, transmission, and playback by a terminal.

The term “storage unit” refers to a non-transitory storage resource, such as a magnetic storage device, a semiconductor memory device, or a network-based storage service, that is used to store audio data and other associated data for later retrieval and distribution.

The term “memory unit” refers to a storage resource, such as a main memory, a database, or a metadata repository, that stores identification information, delivery management information, and other control data used by the processor to manage generated content and operations.

The term “identification information” refers to data, such as identifiers, keys, or tags, that uniquely or selectively identify instances of text information for audio content, audio data, and related user requests within the system.

The term “delivery management information” refers to control data associated with provision of audio content, including at least one of delivery time, theme, access history, status flags, and resource location information, which are used by the processor to manage distribution and playback operations.

The term “format enabling streaming or downloading” refers to a data representation and protocol arrangement, such as a file format and a network access method, that allows a terminal to sequentially receive and play audio data as a stream or to retrieve and store the entire audio data file for later playback.

The term “number of words or tokens” refers to a quantitative measure of content length, wherein a “word” is a language unit separated by delimiters and a “token” is a minimal processing unit defined by a tokenization algorithm used by a generative AI model.

The term “additional prompt sentence” refers to a prompt sentence generated after initial text information has been obtained, the additional prompt sentence including instructions that refer to or build upon the existing text information in order to complement, extend, or edit the content toward a target length or quality.

The term “playback instruction” refers to control information transmitted from a terminal to the server, indicating that the terminal requests initiation or continuation of reproduction of audio data associated with a particular user request or identification information.

In one embodiment, a server, a terminal, and a network cooperate to implement the claimed system. The server includes at least one processor, a main memory, a non-transitory storage unit, and a network interface. The terminal includes a processor, a display unit, an input unit such as a touchscreen, an audio output unit such as a speaker or headphone interface, and a communication module for connecting to the server via a communication network such as the Internet.

The terminal presents a graphical user interface that allows a user to specify a delivery time and a theme. The terminal transmits the specified delivery time and theme, together with optional user identification data, to the server using a network protocol such as HTTPS. The transmission uses a structured request format, for example an HTTP POST message whose body contains the delivery time and the theme encoded as text parameters. The terminal then waits for a response from the server and, upon receiving audio data, the terminal decodes the audio data using an operating system-provided media framework and outputs the decoded audio signal through the audio output unit.

The server stores executable program modules in the storage unit, and the processor loads and executes these program modules using the main memory. In one embodiment, the server executes a web application framework program implemented in a general-purpose programming language such as Python, Java, or JavaScript. The web application framework receives network requests from the terminal via the network interface, parses the received text data, and passes structured representations of the delivery time and theme to a content generation module.

The server calculates a target length for audio output based on the delivery time. In one example, the server maintains in the memory a speech rate parameter representing an average number of spoken words per minute, such as 150 words per minute. The server multiplies the delivery time in minutes by the speech rate parameter to estimate a number of words to be generated for the audio content. The server may further convert the estimated number of words into an estimated number of tokens using a tokenization model consistent with a generative AI model, for example by multiplying the word count by a factor representing an average tokens-per-word ratio. The server stores this target length and the intermediate calculations in the memory as numerical data associated with a request identifier.

The server constructs a prompt sentence for a generative AI model by combining the theme, the target length, and a generation structure specification. The server generates a text string that may include explicit instructions about the topic, the desired structure of the content, and the approximate length. For example, the server may construct a prompt sentence such as:
“Generate an English podcast script about the latest technology that will take about 45 minutes to read aloud (around 6,000-7,000 words). Include an introduction, several main sections covering recent advancements, and a conclusion.”

In another example, when the user specifies a financial theme and a shorter delivery time, the server may construct a prompt sentence such as:
“Generate a concise English podcast script for a 10-minute daily stock market summary, including major indices performance, key company news, and important macroeconomic indicators. Aim for approximately 1,500 words.”

The server then supplies the prompt sentence to a generative AI model. In one embodiment, the generative AI model is a neural network-based language model having a transformer architecture including multiple self-attention layers, feedforward layers, and layer normalization components. The model parameters, such as weight matrices for query, key, and value projections, are stored in a model storage unit managed by an AI service platform.

The server transmits the prompt sentence and configuration parameters, such as a maximum token count, a temperature value, and a top-k or top-p sampling parameter, to the AI service platform via an application programming interface over the communication network.

The generative AI model processes the prompt sentence by converting the text into a sequence of tokens using a predetermined tokenization algorithm, such as byte-pair encoding or unigram tokenization. The model embeds the tokens into a high-dimensional vector space, applies positional encoding, and then propagates the resulting vectors through the transformer layers. Each layer computes attention scores and combines context information across the sequence. The model outputs a probability distribution over a vocabulary at each generation step and selects tokens according to the sampling parameters. The server receives the generated token sequence from the AI service platform and decodes the sequence back into text information representing a script for audio content.

The server post-processes the generated text information for audio content using deterministic algorithms executed by the processor. In one embodiment, the server counts the number of words or tokens in the generated text by scanning the character sequence and applying delimiter rules or by re-applying the same tokenization model used by the generative AI model. The server compares the obtained length with the previously calculated target length. When the length deviates from a predefined acceptable range relative to the target length, the server generates an additional prompt sentence that references the existing text and instructs adjustment. For example, when the content is shorter than desired, the server may generate an additional prompt sentence such as:
“Extend the previous script by adding one more detailed section about applications of artificial intelligence in healthcare, maintaining the same tone and style.”

When the content is longer than desired, the server may generate an additional prompt sentence such as:
“Shorten the previous script by removing redundant explanations and summarizing each section so that the total reading time is approximately 20 minutes.”

The server inputs the additional prompt sentence and the previous text to the generative AI model, which then generates complementary or edited text. The server merges the original and the additional text segments according to predetermined rules, for example by concatenating, inserting at designated section boundaries, or replacing specific sections. This iterative adjustment process allows the server to control the overall length and structure of the text information according to the target length by applying explicit, algorithmically generated constraints, rather than merely accepting a single uncontrolled output.

The server converts the finalized text information for audio content into audio data using a speech synthesis unit. In one embodiment, the speech synthesis unit is implemented by a text-to-speech engine accessible through a network-based interface. The server transmits the text information, a language code, a voice identifier, and audio encoding parameters to the text-to-speech engine. The text-to-speech engine performs text normalization, converts the normalized text into phoneme sequences, applies a prosody model to determine accent, intonation, and timing, and then uses a neural vocoder, such as a convolutional or autoregressive neural network, to generate waveform samples. The engine returns audio data encoded in a format such as a compressed audio bitstream.

The server may perform additional digital signal processing on the received audio data. For example, the server may employ a media processing library to normalize volume levels across different segments, resample the audio to a uniform sampling rate, and encode the audio using a predetermined bitrate suited to the target network conditions. The server may also measure the duration of the audio data by parsing the audio headers and dividing the total number of samples by the sampling rate, and the server may record this measured duration in association with the request identifier.

The server stores the generated audio data in the storage unit, which can be a mass storage device or a network-based object storage service. The server also stores metadata, including identification information, the user's theme, the delivery time, the target length, the measured duration, and a location identifier for the audio data, in a memory unit such as a relational database. The server maintains indices or keys in the database so that the processor can efficiently retrieve the audio data and its metadata when a terminal issues a playback instruction. This data structure organization reduces search time and improves scalability when managing a large number of generated audio contents.

The server provides the audio data to the terminal by generating a resource locator such as a uniform resource identifier corresponding to the stored audio data. In one embodiment, the server generates streaming-compatible resources, such as segmented audio files and a playlist description file, to allow the terminal to stream the audio progressively. The server transmits to the terminal metadata including the resource locator and information about the audio format and duration. When the terminal later sends a playback instruction referencing this metadata, the server reads the corresponding audio data from the storage unit and transmits it to the terminal in response.

The server thereby improves computer technology in multiple respects. By calculating a target length from a delivery time and encoding this target into a prompt sentence and subsequent additional prompt sentences, the server implements a length control algorithm that operates directly on the generative AI model's token space. This reduces variance in generated content length, which leads to more predictable processing time and network usage. The server can allocate model inference resources and network bandwidth according to predictable content sizes, improving computational efficiency and reducing communication load.

Furthermore, the server's iterative adjustment mechanism, based on explicit measurement of generated text length and the generation of additional prompt sentences referencing prior content, provides a non-conventional control loop that differs from simple one-shot text generation. The server does not merely automate a human author's drafting; instead, the server exploits length metrics, tokenization behavior, and neural generation parameters to achieve a technical improvement in content-length predictability and resource management. This approach reduces the likelihood of generating excessively long or short content, thereby lowering wasted computation and storage and decreasing the need for manual editing.

The server's integration of generative AI processing, speech synthesis, and structured metadata storage also improves data management. By maintaining unified metadata linking text information, audio data, and user-specified constraints, the server enables efficient caching, reuse, and update of generated content. The server can detect when an existing audio file already satisfies a new user request with similar parameters, thereby avoiding unnecessary regenerations and lowering system load.

In addition, the generative AI model in this embodiment is trained using a supervised learning and self-supervised learning framework. The model parameters are optimized by minimizing a loss function such as cross-entropy between predicted token distributions and ground-truth tokens. The training process employs gradient-based optimization, such as stochastic gradient descent or an adaptive optimizer, and updates weight matrices according to backpropagation. Data augmentation techniques, such as random masking of input tokens and sequence truncation, are applied to increase model robustness. These training details indicate that the model's behavior results from a defined mathematical optimization procedure, and the server's control of the model through structured prompt sentences and quantitative length constraints is a technical tool that leverages this trained behavior for improved computational performance.

The AI-driven length control mechanism differs from human-centric editing, because the server applies quantitative measures, token-level constraints, and predefined convergence criteria in an automated loop that terminates when the generated content falls within a specified tolerance range. This non-human method of controlling generative behavior is configured specifically to optimize computing performance and user experience and is not merely automating a manual editorial process.

In alternative embodiments, the server may employ different algorithms for estimating the target length, such as dynamically adjusting the words-per-minute parameter based on previously measured speech durations for similar content or using a regression model that maps text features to predicted reading time. The server may also adapt the prompt sentence structure based on historical performance of the generative AI model, for example selecting different prompt templates for different themes or delivery time ranges to further stabilize content length. The generative AI model may comprise different neural architectures, such as a hybrid of transformer and recurrent layers, or may be deployed on specialized hardware accelerators, while the length control and prompt-generation logic on the server remains applicable.

In another embodiment, the server may incorporate error detection and correction mechanisms in the text post-processing phase, such as checking for missing sections prescribed in the prompt sentence, verifying the presence of required keywords related to the theme, or performing syntactic validation. When such checks fail, the server may generate corrective additional prompt sentences instructing the generative AI model to fill in missing sections or to rewrite portions for clarity, thus improving the quality and consistency of the generated text and the corresponding audio.

In a further embodiment, the server may adjust audio encoding parameters depending on the target length and measured network conditions. For longer delivery times, the server may choose a lower bitrate to reduce total file size and transmission time without significantly affecting perceived audio quality. For shorter contents, the server may select a higher bitrate to improve quality. These dynamic encoding decisions reduce communication load and improve overall system responsiveness.

Through these configurations, the server, terminal, and generative AI model cooperate to form a system that not only generates and distributes personalized audio content, but also improves computer operation by controlling generation length, optimizing resource usage, organizing data structures for scalable retrieval, and adapting encoding and streaming behavior based on measurable parameters.

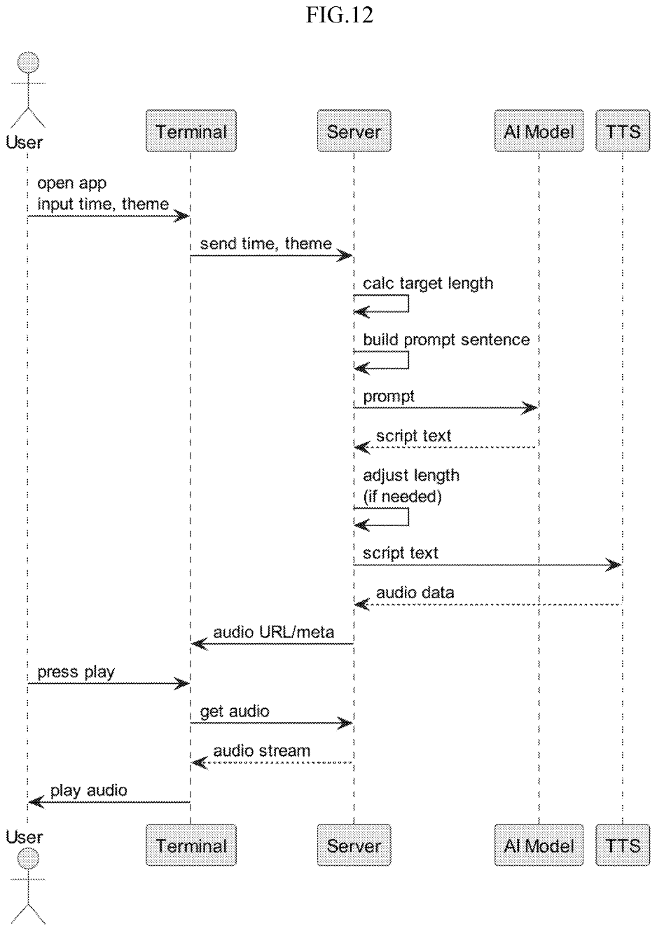

The following describes the processing flow using FIG. 12.

### Step 1:

The user operates the terminal to launch an application and opens an input screen for audio content generation. The terminal receives, as input, a delivery time and a theme entered by the user via a touchscreen keyboard or other input device. The terminal performs basic validation on the input, such as checking that the delivery time is a positive numeric value and that the theme string is not empty. Based on this input, the terminal generates a structured request object in memory, associating fields for delivery time, theme, and user identifier, and outputs this request object to a communication module.

### Step 2:

The terminal transmits the structured request to the server over a network using a protocol such as HTTPS. The input of this step is the request object containing the delivery time and the theme; the output is a network message sent to a predefined server endpoint. The terminal serializes the request object into a text-based format, for example an HTTP POST body with key-value pairs, and writes the serialized bytes into a transmission buffer that the communication module sends through a network interface.

### Step 3:

The server receives, as input, the network message from the terminal at a web application interface. The server parses the message, extracts the delivery time and the theme, and writes these values into internal data structures in main memory. The server performs server-side validation, including range checks on the delivery time and length checks on the theme string. The output of this step is a validated request record that includes a normalized delivery time, a sanitized theme, and an assigned request identifier stored in a memory data structure.

### Step 4:

The server calculates a target length for the audio content. The input of this step is the normalized delivery time from the validated request record. The server retrieves a stored speech rate parameter, for example 150 words per minute, from configuration data. The server multiplies the delivery time by the speech rate parameter to compute an estimated word count, and optionally multiplies the word count by a token-ratio parameter to estimate the number of tokens. The server stores the resulting target length values in association with the request identifier. The output of this step is a target length record that specifies at least one of an estimated word count and an estimated token count.

### Step 5:

The server generates a prompt sentence for a generative AI model. The input of this step is the theme string together with the target length record. The server concatenates template text fragments with the theme and the target length, and may insert structural constraints such as section headings. For example, the server may generate the prompt sentence:
“Generate an English podcast script about the latest technology that will take about 45 minutes to read aloud (around 6,000-7,000 words). Include an introduction, several main sections, and a conclusion.”

The server writes this prompt sentence into a request payload for the generative AI model. The output of this step is a text payload that contains the prompt sentence and associated generation parameters such as maximum token count and temperature.

### Step 6:

The server transmits the prompt payload to the generative AI model execution environment via an API call. The input of this step is the text payload containing the prompt sentence and the generation parameters. The server serializes the payload into a request body compatible with the model provider's interface, sends the serialized data through the network interface, and waits for a response. The output of this step is a pending model inference request tracked by the server using the request identifier.

### Step 7:

The server receives, as input, the model response containing generated text data from the generative AI model. The model provider returns a sequence of tokens or a complete text string. The server decodes tokens to characters when necessary and concatenates multiple chunks into a single script. The server stores this generated text in memory as text information for audio content, associated with the request identifier. The output of this step is a generated script string that represents candidate content for speech synthesis.

### Step 8:

The server evaluates the length of the generated script string. The input of this step is the generated text and the target length record. The server applies a tokenizer or textual analysis routine to count words or tokens in the generated text. The server compares the measured length to the target length and determines whether the difference is within an acceptable tolerance range, such as ±10%. The server stores a length evaluation result flag indicating whether the script is too short, too long, or acceptable. The output of this step is the combination of a measured length value and a status indicator.

### Step 9:

The server optionally performs iterative adjustment of the text information for audio content when the length evaluation indicates a deviation. The input of this step is the generated text, the length status indicator, and the target length. When the script is shorter than desired, the server constructs an additional prompt sentence that references the existing text and instructs extension, such as:
“Extend the previous script by adding one more detailed section about applications of artificial intelligence in healthcare, maintaining the same tone and style.”

When the script is longer than desired, the server constructs an additional prompt sentence instructing summarization or reduction, such as:
“Shorten the previous script by removing redundant explanations and summarizing each section so that the total reading time is approximately 20 minutes.”

The server sends the additional prompt sentence and the existing text to the generative AI model and receives complementary or edited text. The server then combines the original and additional text according to predetermined rules, for example by appending or replacing specific sections. The output of this step is an adjusted script string whose length is closer to the target length.

### Step 10:

The server finalizes the text information for audio content. The input of this step is either the initially acceptable script or the adjusted script from the previous step. The server performs formatting operations such as inserting paragraph breaks, headings, and punctuation adjustments. The server may also perform content checks to ensure that the theme-related keywords appear and that required sections are present. The server then stores the finalized text in a persistent or semi-persistent memory area. The output of this step is a finalized script object ready for speech synthesis.

### Step 11:

The server converts the finalized text information into audio data using a speech synthesis unit. The input of this step is the finalized script object and synthesis parameters such as language, voice type, and audio format. The server transmits the text and parameters to a text-to-speech engine via a network or local interface. The text-to-speech engine performs text normalization, phoneme conversion, prosody estimation, and waveform generation using an acoustic model. The server receives the resulting audio bitstream and stores it temporarily in memory. The output of this step is raw audio data representing synthesized speech corresponding to the script.

### Step 12:

The server performs post-processing and storage of the audio data. The input of this step is the raw audio data from the speech synthesis unit. The server may use a media processing library to normalize volume levels, resample the audio to a standard sampling rate, and encode the audio using a specified codec and bitrate. The server measures the duration of the processed audio by analyzing the frame metadata and confirming that it is consistent with the delivery time. The server then writes the processed audio data into a storage unit and records in a database the location of the stored audio, together with metadata including the request identifier, theme, delivery time, and measured duration. The output of this step is persistent audio data stored in the storage unit and associated metadata stored in the database.

### Step 13:

The server prepares delivery information for the terminal. The input of this step is the metadata and storage location of the audio data. The server constructs a resource locator, such as a URL, that the terminal can use to access the audio file or an associated streaming resource. The server bundles this locator with information such as the audio format, estimated duration, and any access tokens or permissions. The output of this step is a response payload containing delivery information that is transmitted back to the terminal over the network.

### Step 14:

The terminal receives, as input, the response payload containing the delivery information from the server. The terminal parses the payload to extract the resource locator and metadata, and stores these values in a local data structure related to the current user session. The terminal updates the user interface to present information such as the theme and the duration of the available audio content and displays controls such as a playback button. The output of this step is an updated user interface state showing that personalized audio content is ready for playback.

### Step 15:

The user operates the terminal to initiate playback by activating the playback control displayed on the user interface. The terminal receives this user action as input and generates a playback instruction that references the resource locator and associated metadata. The terminal passes this playback instruction to a media playback module within the terminal operating environment. The output of this step is a playback request issued internally by the terminal to obtain and render the audio data.

### Step 16:

The terminal retrieves and plays the audio data. The input of this step is the playback request including the resource locator from the previous step. The terminal opens a network connection to the server or to the storage resource indicated by the locator and requests the audio data, either as a download or as a stream. The terminal buffers incoming audio packets, decodes the encoded audio frames using an audio codec, and sends digital audio samples to the audio output subsystem. The terminal converts the digital samples to analog signals through a digital-to-analog converter and outputs the sound through speakers or headphones. The output of this step is audible playback of the synthesized audio content that matches the user-specified delivery time and theme.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content generation and delivery systems that rely on generative AI models typically accept only a simple topic or keyword and return a generic script or audio output. Such systems often do not (i) tightly couple end-user distribution constraints (such as required start and end times) with the generative process, (ii) systematically incorporate structured, up-to-date external information into the generative AI input, or (iii) provide an integrated workflow that supports iterative human editing and precise scheduling of final delivery. As a result, these systems tend to produce content whose length does not match the desired distribution slot, whose information is outdated or poorly aligned with the user's intent, and whose production and distribution steps require manual, error-prone coordination across multiple disconnected tools.

From the perspective of computer technology, existing architectures generally treat the generative AI model as a black-box text generator invoked with ad-hoc prompts, without a defined control layer in the server that computes target content length from structured time data, assembles a machine-readable information set from heterogeneous external sources, and deterministically generates a prompt sentence that encodes these constraints and resources.

This leads to inefficient use of computing resources (for example, repeated or unnecessary API calls, trial-and-error prompt tuning on the client side), inconsistent output quality, and increased latency due to manual post-processing and resubmission. Furthermore, existing systems do not provide a unified mechanism on the server to associate the generated or user-edited script, synthesized or recorded audio data, and distribution time information in a way that supports automated, timed distribution without additional orchestration.

Accordingly, there is a need for an improved computer-implemented system that, under server control, (i) acquires user-specified distribution time, topic, and emotion information from a user terminal, (ii) collects and structures external information based on the topic, (iii) computes a target content length from the distribution time information, (iv) programmatically generates a prompt sentence reflecting these constraints and resources for input to a generative AI model, (v) generates an audio content script via the generative AI model, (vi) optionally incorporates user edits of the script, and (vii) synthesizes or manages corresponding audio data in association with the distribution time information and automatically controls distribution. By integrating these operations into a cohesive server-side processing pipeline, the invention seeks to improve the functioning of the computer system itself in terms of controllability of generative AI output, resource efficiency, automation of scheduling, and reliability of end-to-end content delivery.

The specific processing by the specific processing unit 290 of the data processing device 12 in Example 2 is realized by the following means.

The present invention provides a server comprising a processor and a storage device, wherein the processor is configured to receive, from a user terminal, distribution time information, topic information, and emotion information specified by a user, to acquire, based on the topic information, related information from one or more information providing services via a communication network and store the acquired related information as a structured information set in the storage device, to calculate a target content length from the distribution time information, to generate a prompt sentence including at least the topic information, the emotion information, the target content length, and at least part of the structured information set as an instruction sentence for causing a generative AI model to generate an audio content script, to input the prompt sentence into the generative AI model and obtain the audio content script generated based on the structured information set, to provide the audio content script to the user terminal for review and editing by the user, to receive, from the user terminal, an edited script corresponding to the audio content script, to generate audio data by using a speech synthesis technique based on the audio content script or the edited script, to store the generated audio data in association with the distribution time information, and to control distribution of the audio data in accordance with the distribution time information. This enables the server to technically improve the end-to-end content generation and distribution process by automatically constraining the generative AI output with precise temporal requirements, integrating structured external information into a machine-generated prompt sentence, reducing manual coordination between separate tools, and providing a unified, computer-controlled pipeline that deterministically links user intent, generative processing, optional user editing, and timed delivery of audio content.

The term “processor” refers to a hardware or virtual computing element, such as a central processing unit or a processing core in a computing apparatus, that executes instructions to perform the functions described in the present disclosure.

The term “user terminal” refers to an information processing apparatus operated by a user, such as a personal computer, a tablet device, a smartphone, or a similar communication device, that is capable of transmitting data to and receiving data from a server over a communication network.

The term “distribution time information” refers to time-related data specified by a user, including at least one of a start time, an end time, a duration, or a time window, defining when audio content is to be made available or delivered to listeners.

The term “topic information” refers to data representing a subject, theme, or main idea designated by a user, which is to be used as a basis for generating content by a generative AI model.

The term “emotion information” refers to data representing a desired emotional tone, mood, or affective state, such as “joyful,” “serious,” or “relaxed,” to be reflected in the style or expression of the content generated by a generative AI model.

The term “information providing service” refers to a network-accessible service, such as a search service or a news aggregation service, that provides information items including at least textual data via a communication interface in response to a query.

The term “communication network” refers to any wired or wireless network infrastructure, including at least one of the Internet, a local area network, or a cellular network, that enables data communication between the server, the user terminal, and external services.

The term “related information” refers to information items, including at least one of text data, metadata, or link data, that are obtained from an information providing service and that have relevance to the topic information.

The term “structured information set” refers to an organized collection of related information in which each information item is represented in a standardized format, including at least one of a title, a summary, a body text, and a reference identifier, such that the information can be programmatically processed by the processor.

The term “storage device” refers to a non-transitory computer-readable storage medium, such as a semiconductor memory, a magnetic storage device, an optical storage device, or a storage system, that stores data and programs used by the processor.

The term “target content length” refers to a duration value calculated from the distribution time information, indicating a desired length of audio content to be generated or delivered, and expressed in at least one unit of time such as seconds or minutes.

The term “prompt sentence” refers to instruction data, including natural language text and optionally structured metadata, generated by the processor to be input to a generative AI model in order to cause the generative AI model to generate content in accordance with specified constraints.

The term “instruction sentence” refers to a part or the entirety of a prompt sentence that explicitly describes directives, conditions, or requirements for the generative AI model, including at least one of topic constraints, style constraints, and length constraints.

The term “generative AI model” refers to a machine learning model, such as a neural network-based language model, that receives input data including a prompt sentence and generates output data including at least a natural language text sequence based on learned parameters.

The term “audio content script” refers to a text representation of content intended for audio presentation, including at least one of narration, dialogue, or segment descriptions, that is generated by a generative AI model based on a prompt sentence and a structured information set.

The term “speech synthesis technique” refers to a computer-implemented process, such as text-to-speech synthesis, that converts a text input, including an audio content script, into audio data representing a human-perceivable sound signal.

The term “audio data” refers to digital data representing an audio signal, encoded in a format suitable for storage, transmission, or playback, such as a pulse code modulation format or a compressed audio format.

The term “edited script” refers to a modified version of an audio content script in which at least a part of the text has been changed, added, or removed by a user through an operation performed on a user terminal.

The term “distribution” refers to the act of making audio data or audio content available to listeners, including at least one of streaming, downloading, or broadcasting, in accordance with distribution time information.

The term “external recording device” refers to an audio capturing apparatus separate from the server, such as a recording function of a user terminal or a dedicated recording device, that records audio corresponding to an audio content script or an edited script and outputs audio data to the server.

In one embodiment, a server cooperates with at least one user terminal to implement the claimed system. The server includes a processor, a main memory, a non-transitory storage device, and a network interface, and operates under control of an operating system such as a server-grade operating system. The terminal includes a processor, a memory, a display, an input interface, a microphone, and a network interface, and operates under control of a client operating system such as a mobile or desktop operating system. The server and the terminal communicate over a communication network such as the Internet via standard communication protocols including HTTP over TLS.

The server executes server-side application software implemented, for example, using a server-side framework and a database management system such as a relational database. The server stores program instructions and data structures in the storage device, including program modules for user interaction management, external information collection, prompt sentence generation, generative AI model interaction, script management, audio synthesis, and distribution control. The terminal executes client-side application software such as a web browser or a dedicated application, and provides a graphical user interface to the user.

The server stores, in the storage device, a plurality of logical data structures including at least a user table, a request table, an information item table, a script table, and an audio asset table. The server represents each user request as a record in the request table containing fields such as a request identifier, a user identifier, topic information, emotion information, and distribution time information including at least a start time and an end time. The server represents each external information item as a record in the information item table containing fields such as a title field, a summary field, a body text field, a source identifier, and a timestamp field. The server groups a plurality of the records in the information item table into a structured information set associated with a particular request identifier.

The server uses an external information collection module to communicate with one or more information providing services, such as search services and news aggregation services, via their network interfaces. The server constructs query messages in a structured format including query text derived from the topic information, optional language parameters, date range parameters, and result count parameters. The server transmits these query messages using HTTP or another web protocol and receives responses in a structured serialization such as a structured text or hierarchical data format. The server parses each response by extracting relevant fields including a title element, a description element, a content element, and a link element. The server normalizes the character encoding to a unified encoding, removes markup tags and control characters, and stores sanitized text segments into the information item table.

The server computes a target content length from the distribution time information by calculating the difference between the start time and the end time. The server expresses the target content length in a time unit such as seconds or minutes and optionally classifies it into categories such as short, medium, or long. The server stores the target content length and any derived category in association with the request identifier. By computing the target content length on the server side and encoding this value into subsequent processing, the server reduces the need for iterative trial-and-error prompts at the client, thereby reducing network traffic and processing latency.

The server executes a prompt generation module that reads, from the storage device, the topic information, the emotion information, the target content length, and the structured information set. The server formats the structured information set into a normalized representation, for example by extracting for each information item a title and a list of key points. The server orders the information items using a deterministic ranking rule, such as a combination of recency and textual similarity to the topic information computed by an embedding-based similarity measure or a keyword overlap metric. The server then generates a prompt sentence that encodes explicit constraints and resources for the generative AI model.

In one concrete example, the server constructs a prompt sentence such as:
“The user has requested a radio-style audio program about ‘latest scientific technology’ with a target duration of 30 minutes.

Use a clear, conversational style suitable for a general audience, and reflect an overall ‘enthusiastic and optimistic’emotional tone.

Create an audio content script including: an opening talk, several main segments, short transitions between segments, and a closing talk.

Please ensure that the total speaking time is approximately 30 minutes, assuming a speaking speed of about 150 words per minute.

Use the following collected information as your primary reference and reorganize it into an engaging and coherent script. Do not simply list the items; instead, integrate them into a narrative flow:
1. Title: [Title of article 1]
   Summary: [Summary of article 1]
   Main points: [Key point A], [Key point B], [Key point C]
2. Title: [Title of article 2]
   Summary: [Summary of article 2]
   Main points: [Key point D], [Key point E]
3. Title: [Title of article 3]
   Summary: [Summary of article 3]
   Main points: [Key point F], [Key point G], [Key point H]

Explain technical terms in a way that non-experts can understand, and include smooth transitions between segments and a concise recap at the end.”

The server generates this prompt sentence by deterministic string operations such as concatenation, template substitution, and control-flow based insertion of items, executed by the processor. The server configures the prompt sentence to include not only human-readable instructions but also implicit alignment with machine constraints, such as target length mapping to approximate token count. This controlled prompt sentence generation improves the determinism and quality of the generative AI output, as compared to ad-hoc prompts manually constructed at the terminal.

The server communicates with a generative AI model deployed either on the same machine or on a remote machine. In one embodiment, the generative AI model is a transformer-based language model trained on large-scale text data. The server represents the generative AI model as a sequence of neural network layers including token embedding layers, multiple self-attention blocks, feed-forward layers, and output projection layers. The server inputs the prompt sentence into a tokenizer that converts the prompt sentence into a sequence of integer token identifiers. The generative AI model processes the tokens through the attention mechanism to compute contextualized representations and progressively predicts subsequent tokens using a probability distribution parameterized by learned weights.

The server, during training of such a model (in an offline phase), uses a loss function such as cross-entropy between predicted token distributions and ground truth tokens. The server updates network weights by an optimization algorithm such as stochastic gradient descent with momentum or an adaptive gradient method. The server may apply regularization techniques including dropout and weight decay, and data augmentation techniques such as random masking of terms or sentence reordering during pretraining. The server uses the trained generative AI model in an inference phase to generate an audio content script that is constrained by the encoded target content length and guided by the structured information set.

The server configures model inference parameters such as temperature, top-k or top-p sampling thresholds, and maximum output token length. The server sets the maximum output token length based on the target content length, such that the generated script approximates the desired audio duration when read at an average speaking rate. By mapping the target content length into a token budget, the server reduces the likelihood of under- or over-length scripts, thereby improving technical control over resource allocation (memory, bandwidth) and scheduling.

The server stores the generated audio content script as a record in the script table, linked to the corresponding request identifier. The server then provides the audio content script to the terminal using a structured response. The terminal renders the script on the display using a text rendering component, and allows the user to inspect and edit the script. The terminal can highlight logical sections such as an opening, main segments, and closing based on section markers in the script. The user can adjust wording, insert personalized comments, or reorganize segments.

The terminal transmits the edited script back to the server. The server updates the script table by storing an edited script field separate from the original generative script field. The server preserves both versions to allow analysis of user modifications, and associates the edited script with the same distribution time information. The server then selects either the original audio content script or the edited script for subsequent audio generation based on a control parameter, such as a user preference flag.

The server includes an audio synthesis module configured to apply a speech synthesis technique to the selected script. In one embodiment, the server uses a neural text-to-speech (TTS) engine that converts text into audio waveforms. The server converts the text tokens into phoneme sequences using a grapheme-to-phoneme model, aligns phonemes with prosodic features such as pitch and duration, and generates a waveform using a vocoder model. The server can adjust prosodic parameters based on the emotion information, for example raising average pitch and increasing speaking rate for “excited” content, or lowering pitch and slowing speaking rate for “calm” content. The server outputs audio data in a digital format such as linear pulse code modulation or a compressed format.

The server performs optional post-processing on the audio data, such as dynamic range compression, normalization of peak levels, and encoding into distribution formats such as compressed audio formats. The server stores each audio asset in the audio asset table with fields including a file path, a duration, a bitrate, and a reference to the associated script and request.

The terminal, in another embodiment, records audio content directly based on the script displayed on the terminal. The terminal drives the microphone to capture analog sound and converts the analog sound into digital samples using an analog-to-digital converter. The terminal buffers the samples in memory and applies an encoder to compress the data. The terminal transmits the recorded audio to the server along with metadata linking the recording to the edited script.

The server stores the received audio as an externally recorded asset and associates it with the request. The server treats both synthesized and user-recorded audio data as interchangeable assets for distribution control, thereby enabling a hybrid workflow. The server maintains a unified structure for managing audio assets, including indexing by request identifier, storage location, and distribution time.

The server includes a distribution control module that uses the distribution time information to schedule publication of the audio data. The server registers timed tasks in a scheduling subsystem that monitors current time and triggers actions when the distribution start time is reached. The server, when a scheduled time occurs, retrieves the corresponding audio asset, updates its status field to indicate availability, and exposes a network address through which listeners can access the audio content. The server may generate a feed entry, such as a structured description containing the title, summary, and audio URL, for a distribution channel. The server can also integrate with external distribution platforms by invoking their application interfaces, thereby uploading audio files and metadata.

From a technical perspective, the server improves computer technology by implementing a server-side control layer that transforms loosely specified human intent (topic, emotion, distribution slot) into rigorously structured machine representations, including a structured information set, a computed target content length, and a constrained prompt sentence. The server thereby reduces variability and inefficiency in the use of the generative AI model. By calculating a target content length and mapping it to a maximum token count and other model parameters, the server minimizes unnecessary model computations and memory usage. By pre-structuring external information and encoding it into the prompt sentence, the server reduces the need for repeated AI calls when the topic or distribution time changes, enabling more efficient caching and reuse of intermediate structured data.

The server's modular architecture and data flow also improve data management. The server keeps explicit associations between requests, information items, scripts, and audio assets in structured tables, which enables indexed retrieval and reduces lookup times. The server enforces consistent formats and relationships, which simplifies validation and reduces the probability of data inconsistency. By offloading complex orchestration tasks—such as prompt construction, result validation, time-based scheduling, and audio asset management—from the terminal to the server, the system uses network resources more efficiently and reduces client-side computation requirements.

The generative AI model in this system is not merely used as a generic text generator; instead, the server constrains and guides the model through specifically engineered prompt sentences that encode structured information and precise temporal constraints. The server thus uses the model in a non-conventional manner, leveraging its architecture (e.g., transformer layers, attention mechanisms) while controlling input and output space through computer-implemented rules. The server can, for example, implement a feedback mechanism that compares the generated script length (computed as a word or token count) with the target content length and, when a discrepancy exceeds a threshold, automatically generates an adjusted prompt sentence with explicit instructions such as “shorten segment 2 by approximately 3 minutes.” This closed-loop control yields improved alignment between generated content and real-world scheduling requirements.

The system also differs from manual content creation in that the server applies algorithmic rules to structures that are impractical to manage manually. For instance, the server may compute semantic similarity scores between each information item and the topic information using vector embeddings and prioritize higher-scoring items in the prompt. The server may also apply thresholding to remove items with low relevance scores. Such computational operations on high-dimensional embeddings, matrix multiplications, and non-linear transformations are not mere automation of human tasks but reflect a reliance on specialized computing capabilities.

In alternative embodiments, the server can deploy different types of generative AI models, such as an encoder-decoder model or a mixture-of-experts model. The server can incorporate auxiliary models that estimate speaking rate or predict content density to refine the mapping between token count and audio duration. The server can adjust processing algorithms to account for language differences, for example by selecting language-specific tokenizers and phoneme sets. The server can also modify the scheduling subsystem to support recurring distribution time patterns or dynamic rescheduling based on listener engagement analytics.

In each of these embodiments, the server, the terminal, and optional external recording devices cooperate under programmatic control to implement a technically grounded workflow that transforms user inputs into distribution-ready audio content. The system's specific data structures, processing modules, and control algorithms provide improved technical effects, including more accurate matching of content length to distribution slots, reduced server and network load through deterministic prompt generation and output control, enhanced reliability of timed distribution, and improved manageability of complex content pipelines that integrate generative AI outputs with user edits and multi-source information.

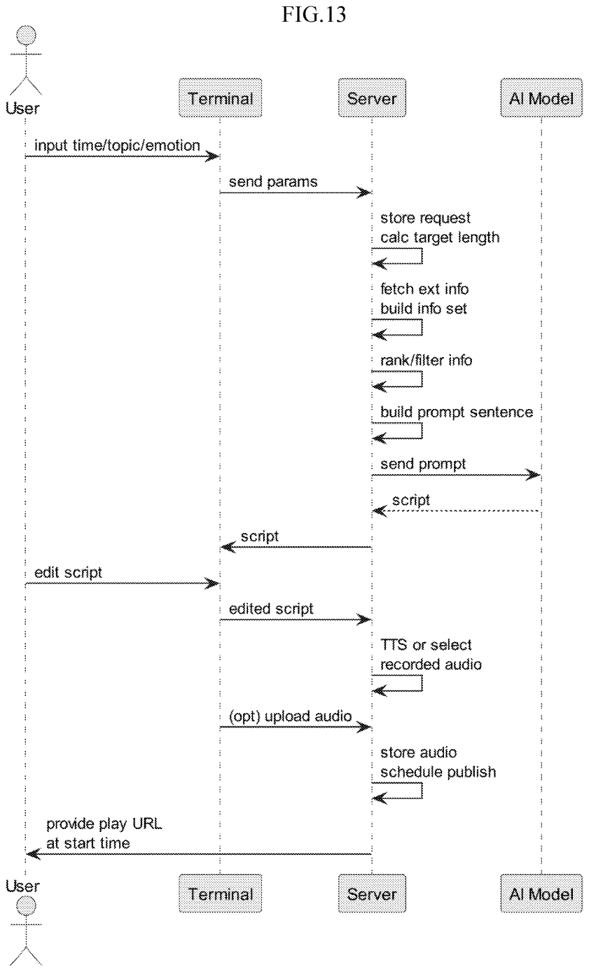

The following describes the processing flow using FIG. 13.

### Step 1:

The user operates the terminal to start a content creation session.

The terminal displays input fields for distribution time information, topic information, and emotion information on a graphical user interface.

Input: No structured input; the terminal presents an empty form.

Output: A form state object on the terminal containing editable fields for start time, end time, topic text, and emotion selection.

### Step 2:

The user inputs the desired distribution time information, topic information, and emotion information via the terminal.

The terminal receives keyboard or touch input, fills the form state object, and performs basic client-side validation such as checking that the end time is later than the start time and that the topic text is not empty.

Input: User keystrokes or touch events representing time values, topic text, and emotion selection.

Output: A validated parameter set on the terminal including structured distribution time information (start time, end time), topic text, and emotion label.

### Step 3:

The terminal transmits the validated parameter set to the server.

The terminal converts the parameter set into a structured message and sends it to a server application endpoint over a secure network connection.

Input: The parameter set containing distribution time information, topic information, and emotion information.

Output: A network request message delivered to the server that encapsulates the parameter set in a structured format.

### Step 4:

The server receives the network request and stores the request parameters.

The server parses the structured message, extracts the distribution time information, topic information, and emotion information, and writes a new record into a request table in a storage device.

Input: The parameter set received from the terminal.

Output: A persistent request record containing a request identifier, user identifier, topic field, emotion field, and time fields.

### Step 5:

The server derives a target content length from the distribution time information.

The server computes the time difference between the end time and the start time, converts this difference into a numeric duration in minutes or seconds, and stores this value in association with the request record.

Input: Distribution start time and distribution end time from the request record.

Output: A target content length value and optionally a length category flag (for example, short, medium, long) added to the request record.

### Step 6:

The server collects related information from information providing services based on the topic information.

The server constructs query strings using the topic information, attaches parameters such as language and result count, and sends multiple query messages to external search and news services. The server receives structured responses, extracts titles, summaries, content bodies, links, and timestamps, normalizes character encodings, and stores each item as a record in an information item table linked to the request identifier.

Input: Topic information from the request record.

Output: A structured information set composed of multiple information item records stored in the storage device and associated with the request identifier.

### Step 7:

The server ranks and filters the collected information items.

The server computes relevance scores for each information item using text analysis techniques such as keyword overlap or embedding-based similarity to the topic information, discards items below a relevance threshold, and orders the remaining items by a combination of recency and relevance.

Input: The structured information set and the topic information.

Output: A filtered and ordered subset of information items forming an ordered information list for prompt construction.

### Step 8:

The server generates a prompt sentence for a generative AI model.

The server reads the topic information, emotion information, target content length, and ordered information list, and formats them into a single coherent text instruction. The server calculates an approximate target word or token count from the target content length and encodes this constraint as explicit guidance in the prompt.

Input: Topic information, emotion information, target content length, and the ordered information list.

Output: A prompt sentence that includes structural instructions (opening, segments, closing), emotional tone requirements, length constraints, and summarized external information.

### Step 9:

The server transmits the prompt sentence to the generative AI model and requests script generation.

The server sends the prompt sentence to a generative AI model interface, sets inference parameters such as maximum token length based on the target content length, and initiates generation. The generative AI model processes the tokenized prompt using its neural network architecture and returns generated text.

Input: The prompt sentence and generation parameters derived from the target content length.

Output: A raw audio content script returned from the generative AI model as a generated text sequence.

### Step 10:

The server post-processes and stores the generated audio content script.

The server removes extraneous whitespace, normalizes line breaks, optionally segments the script into labeled sections, and stores the script in a script table linked to the corresponding request identifier and user.

Input: The raw audio content script from the generative AI model.

Output: A normalized script record stored in the storage device and associated with the request identifier.

### Step 11:

The server provides the audio content script to the terminal.

The server retrieves the stored script record and sends it to the terminal in a structured response, including section markers if present.

Input: The normalized script record.

Output: A network response message containing the audio content script that is delivered to the terminal.

### Step 12:

The terminal displays the audio content script for user review.

The terminal parses the response, loads the script into a text editor component, and renders the script on the display. The terminal may highlight sections such as opening, main segments, and closing to facilitate editing.

Input: The script data received from the server.

Output: A display state in which the script text is visible and editable by the user, and an internal editor state representing the current script content.

### Step 13:

The user reviews and edits the audio content script via the terminal.

The user reads the displayed script, modifies wording, inserts or deletes sentences, reorders sections, and adjusts transitions to match personal style. The terminal captures each edit event, updates the editor state, and maintains an up-to-date edited script in memory.

Input: The initially displayed script and user edit actions.

Output: An edited script held in the terminal's editor state, reflecting the user's modifications.

### Step 14:

The terminal transmits the edited script to the server.

The terminal packages the edited script with the request identifier and user identifier, and sends this data to the server through a network request.

Input: The edited script and associated identifiers.

Output: A structured message delivered to the server containing the final edited script.

### Step 15:

The server receives and stores the edited script.

The server parses the incoming message, locates the corresponding script record, updates or adds a field containing the edited script text, and flags the script as finalized for audio generation.

Input: The edited script and request identifier from the terminal.

Output: An updated script record in the storage device that stores both the original script and the edited script and indicates the finalized status.

### Step 16:

The server generates audio data from the finalized script by using a speech synthesis technique.

The server selects the finalized script, converts the text into phonetic units using a grapheme-to-phoneme module, maps the phonetic sequence to acoustic features such as pitch and duration using a trained acoustic model, and produces an audio waveform using a vocoder model. The server applies prosodic parameters that reflect the emotion information and encodes the waveform into an audio file format suitable for distribution.

Input: The finalized script text and emotion information associated with the request.

Output: Audio data stored as an audio asset record linked to the script and request identifier.

### Step 17:

The terminal, in another mode of operation, records audio content based on the script presented on the display.

The user reads the script aloud, and the terminal captures audio through the microphone, converts analog signals into digital samples, buffers the samples, and encodes them into a compressed audio format.

Input: The user's spoken voice guided by the on-screen script.

Output: A recorded audio file stored temporarily in the terminal's storage.

### Step 18:

The terminal uploads the recorded audio file to the server.

The terminal reads the recorded file from local storage, attaches metadata including the request identifier and script identifier, and transmits the file to the server using a file upload request.

Input: The recorded audio file and associated metadata.

Output: A file upload request delivered to the server containing the recorded audio content.

### Step 19:

The server stores and registers the uploaded audio as an audio asset.

The server writes the received audio file to the storage device, records its file path, duration, and format in the audio asset table, and associates it with the corresponding request and script.

Input: The uploaded audio file and metadata.

Output: A persistent audio asset record that can be used as an alternative to synthesized audio for distribution.

### Step 20:

The server schedules distribution of the audio asset based on the distribution time information.

The server reads the distribution start time and end time from the request record and registers a timed job in a scheduling subsystem that will mark the audio asset as available at the start time and optionally expire or update it at the end time.

Input: The distribution time information and the associated audio asset record.

Output: A scheduled distribution job and a distribution control entry linking timing parameters to the audio asset.

### Step 21:

The server publishes the audio asset at the scheduled time.

The server, when the current time reaches the distribution start time, retrieves the audio asset, exposes a network address or streaming endpoint, updates the asset status to published, and, if necessary, sends notifications or feed updates.

Input: The scheduled job trigger and the stored audio asset.

Output: An accessible audio content endpoint that listeners can use to stream or download the audio during the distribution period.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional audio content delivery systems typically use static playlists, pre-authored scripts, or simple template-based text generation. Such systems are not designed to dynamically adapt content length, structure, and tone to detailed user constraints, such as a precisely specified delivery time, a desired topic, and a real-time emotional state of the user. As a result, (i) the duration of generated content often does not match the user's available listening time, (ii) the information density and structure are not optimized for that duration, and (iii) the style and prosody of the audio output do not adequately reflect or respond to the user's emotional condition.

Furthermore, known systems that do incorporate machine-learning models to generate content generally treat the model as a black box: they send a high-level request and accept whatever length, structure, and tone the model outputs. These systems do not systematically control the generative AI model by constructing prompt sentences that encode explicit constraints on time, structure, and emotion, nor do they perform feedback-based adjustment of the generated script to align the final audio with those constraints. As a consequence, the computing resources of the server are not efficiently utilized, and the user receives content that may be too long, too short, or emotionally inappropriate.

In addition, conventional architectures often perform content generation in a batch manner and then transmit the resulting audio file as a whole. This architecture imposes latency, makes it difficult to provide real-time or near-real-time streaming, and does not exploit the possibility of segment-wise generation and synthesis. It also lacks a mechanism to iteratively refine the prompt and the generated script using emotion feature information derived from user voice or text, thereby limiting personalization.

Accordingly, there is a need for an improved computer-implemented technique that (i) systematically constructs and refines prompt sentences for a generative AI model based on user-specified delivery time, topic, and emotion; (ii) programmatically adjusts the length and writing style of the generated script to match the delivery time and emotional state; (iii) controls speech synthesis parameters such as speaking speed, prosody, and voice quality based on emotion; and (iv) supports both pre-generated and real-time, segment-wise streaming of audio content. Such a technique should improve the functioning of the server as a computing system by coordinating multiple processing stages—information acquisition, prompt construction, generative model invocation, text editing, emotion-driven prosody control, and streaming transmission—in a way that produces time-constrained, emotion-adaptive audio streams with reduced manual intervention and improved computational efficiency.

The specific processing by the specific processing unit 290 of the data processing device 12 in Application Example 2 is realized by the following means.

The present invention provides a server comprising a processor configured to receive user instruction information from a user terminal, the user instruction information including a delivery time designated by a user, a content target, and an emotional state, to perform, on the basis of the content target and the emotional state, an information acquisition process to collect related information from a communication network or an information storage device, and to generate a prompt sentence for a generative information processing model, the prompt sentence instructing the generative information processing model to generate script data for audio under control conditions including the delivery time and the emotional state, to input the prompt sentence into the generative information processing model and to adjust script data for audio generated by the generative information processing model by performing a text editing process including a summarization process or an addition process so that the script data has a length and a writing style corresponding to the delivery time and the emotional state, to input the adjusted script data for audio into a speech synthesis process and to generate audio data by controlling audio output characteristics including speaking speed, prosody, and voice quality in accordance with the emotional state, and to sequentially transmit the generated audio data to the user terminal in synchronization with the delivery time so as to provide the audio data as an audio stream capable of continuous reproduction. This enables the computing system to dynamically control a generative AI model and a speech synthesis engine in a coordinated, constraint-aware manner, thereby improving the technical functioning of the server by producing time-constrained, emotion-adaptive audio streams with reduced latency, improved resource utilization, and enhanced personalization compared to conventional static or template-based audio content generation systems.

The term “user terminal” refers to an electronic apparatus operated by a user, such as a communication device, a computing device, or a display device, that transmits user instruction information to a server and receives audio data or an audio stream from the server.

The term “user instruction information” refers to control information provided by a user via a user terminal, the control information including at least a delivery time, a content target, and an emotional state, and optionally including voice information or character information expressing the user's preferences.

The term “delivery time” refers to a time parameter designated by a user that indicates a desired duration or time frame for reproduction of audio content to be generated and distributed by the server.

The term “content target” refers to a specification of a subject, topic, or category of information that the user wishes to be included in the audio content generated by the server.

The term “emotional state” refers to a psychological condition or mood of the user, such as relaxation, excitement, concentration, joy, or sadness, which is used as a constraint for generating, editing, or reproducing audio content.

The term “processor” refers to an information processing unit, such as a central processing unit or a processing circuit, that executes programs to perform operations including information acquisition, prompt generation, model invocation, text editing, speech synthesis control, and audio transmission.

The term “information acquisition process” refers to a processing sequence in which the processor accesses a communication network or an information storage device to collect related information corresponding to a content target and optionally an emotional state.

The term “communication network” refers to a data communication infrastructure, including at least one of the internet, a local area network, or a wide area network, through which the processor can obtain external information or communicate with a user terminal.

The term “information storage device” refers to a non-transitory storage medium, such as a memory device or a storage system, that stores content data, metadata, or auxiliary information used for generating or editing script data for audio.

The term “related information” refers to information items, such as textual data, metadata, or content descriptors, obtained from a communication network or an information storage device that correlate with a content target and are used as source material for generating script data for audio.

The term “generative information processing model” refers to an artificial intelligence model, such as a generative AI model based on machine learning or neural network techniques, that receives a prompt sentence as input and outputs generated text including script data for audio.

The term “prompt sentence” refers to a text-based instruction, including control conditions such as a delivery time, a content target, an emotional state, and structure or tone constraints, that is input to a generative information processing model to direct generation of script data for audio.

The term “script data for audio” refers to text data representing content of an audio program, including at least a sequence of utterances, segments, or narrative elements intended to be converted into speech by a speech synthesis process.

The term “control conditions” refers to parameters and constraints, including at least a delivery time and an emotional state, and optionally including structure, tone, or content granularity, which are encoded in a prompt sentence to control behavior of a generative information processing model.

The term “text editing process” refers to processing operations applied to script data for audio, including at least one of rearranging, adding, deleting, or rewriting textual segments, in order to satisfy constraints such as length, style, delivery time, or emotional state.

The term “summarization process” refers to a type of text editing process in which script data for audio is compressed by removing or condensing content to reduce the length while preserving essential information.

The term “addition process” refers to a type of text editing process in which script data for audio is extended by inserting new textual content, elaborations, or examples to increase the length or detail of the script.

The term “writing style” refers to linguistic characteristics of script data for audio, including sentence structure, vocabulary, tone, and rhetorical form, which can be adapted according to a delivery time and an emotional state.

The term “speech synthesis process” refers to a computation process in which script data for audio is converted into audio data by a speech synthesis engine, such as a text-to-speech engine implemented using signal processing or neural network techniques.

The term “audio output characteristics” refers to parameters of synthesized speech, including at least speaking speed, prosody, and voice quality, which can be adjusted in accordance with an emotional state.

The term “speaking speed” refers to a rate of utterance in synthesized speech, typically expressed as a number of words or phonetic units per unit time, which can be increased or decreased according to an emotional state or delivery time.

The term “prosody” refers to suprasegmental features of synthesized speech, including intonation, stress, rhythm, and pause patterns, which influence perceived emotional tone and naturalness.

The term “voice quality” refers to auditory characteristics of a synthesized voice, such as timbre, pitch range, and perceived warmth or brightness, which may be selected or controlled to match an emotional state.

The term “audio data” refers to digital data representing sound signals, including at least synthesized speech, that can be decoded and reproduced as audible sound by a playback function of a user terminal.

The term “audio stream” refers to a time-sequential transmission of audio data segments that can be received and reproduced by a user terminal in substantially real time or in a continuous manner.

The term “continuous reproduction” refers to playback behavior in which a user terminal decodes and outputs audio data without perceptible gaps between segments, such that the user experiences an uninterrupted audio program.

The term “program configuration element” refers to a structural unit of an audio program, such as an introduction, a main segment, a subsegment, or a closing, that can be individually generated, synthesized, and transmitted.

The term “partial audio data” refers to a portion of audio data corresponding to at least one program configuration element, which is generated and transmitted separately from other portions.

The term “real-time audio distribution” refers to transmission and playback of audio data in which at least a portion of the audio data is generated and delivered while the audio is being reproduced, such that generation and consumption of the data overlap in time.

The term “voice information” refers to audio data representing spoken utterances or vocal expressions of a user, which can be analyzed to derive an emotional state or emotion feature information.

The term “character information” refers to textual data, such as input characters or strings provided by a user, which can be analyzed to derive an emotional state or emotion feature information.

The term “emotion analysis process” refers to a computation process in which voice information or character information is processed by a model or algorithm to extract emotion feature information or to classify an emotional state.

The term “emotion feature information” refers to quantitative or symbolic data representing characteristics of a user's emotional state, such as emotion categories, scores, or intensities, derived from voice information or character information.

The term “tone instructions” refers to directives included in a prompt sentence that specify a desired emotional tone or stylistic flavor of the script data for audio, such as “calm,” “exciting,” or “comforting.”

The term “program structure instructions” refers to directives included in a prompt sentence that specify structural aspects of an audio program, such as number and type of segments, ordering of segments, or inclusion of introductions and conclusions.

The term “atmosphere of the script data for audio” refers to an overall impression or mood conveyed by the text of the script, determined by factors such as tone, choice of expressions, and prosody-related indications, and shaped so as to correspond to a user's emotional state.

In one embodiment, a server implements the claimed system using a processor, a memory, a network interface, and a non-transitory storage medium. The server executes an operating system such as a general-purpose server operating system and runs an application stack including a web framework (for example, a Python framework), a network communication library (for example, an HTTPS library), and a machine learning runtime (for example, a framework capable of executing neural network models). The server communicates with at least one terminal operated by a user. The terminal is realized by a computing device such as a smartphone, a tablet, a notebook computer, or another network-connected device having a display unit, an input unit, a speaker, a microphone, and a network interface.

A terminal provides a user interface implemented by a native application or a browser-based application. The terminal displays input fields for a delivery time, a content target, and an emotional state, and optionally displays controls to start and stop recording of voice information. The user operates the terminal to input the delivery time (for example, a numerical value in minutes), the content target (for example, “latest science and technology,” “health information,” or “world news”), and the emotional state (for example, free-text expressions such as “I want to relax,” “I am excited,” or “I want to focus”). The terminal converts voice input into text when the user speaks, by using a speech recognition function implemented in the terminal or provided by a network service. The terminal forms user instruction information including at least the delivery time, the content target, and the emotional state, and transmits the user instruction information to the server by an HTTP or HTTPS request.

The server stores the received user instruction information into a structured data record. The server represents the instruction information as a data structure containing fields such as a numeric field for the delivery time, a character string field for the content target, and a character string field for the emotional state. The server may further store identifiers of the terminal, timestamps, and processing status flags into the record. By managing user instruction information in a formal data structure, the server can efficiently index records and schedule downstream processing, which increases processing throughput and reduces access latency when handling many concurrent users.

The server analyzes the content target and the emotional state by using a natural language processing library executed on the processor. The server tokenizes the character strings, removes stop words, and applies part-of-speech tagging to extract noun phrases representing topics. The server represents the extracted tokens as numerical identifiers and stores them in a feature vector associated with the record. The server maps the free-text emotional state to an internal label by applying either a rule table or a trained classifier. The trained classifier is implemented as a neural network, for example, a multilayer perceptron that receives embeddings of the emotional text and outputs probabilities for a fixed set of emotion categories. The server selects the category with the highest probability as the emotional state label and stores this label and its probability score. By converting free-form user text into normalized labels and feature vectors, the server reduces ambiguity and noise in the input data, which allows subsequent processing components to operate with better accuracy and lower computational cost.

In another embodiment, the server derives the emotional state from voice information or character information using an emotion analysis process. The server implements an emotion analysis model as a neural network having a feature extraction front-end and a classification back-end. For voice information, the server converts a waveform into a time-frequency representation such as a Mel-spectrogram and normalizes the amplitude. The server then inputs the spectrogram into a convolutional neural network followed by recurrent layers, such as a sequence of convolutional blocks and a bidirectional gated recurrent unit layer. The network parameters are learned by supervised training, in which the server minimizes a cross-entropy loss function between predicted emotion categories and labeled ground truth, using a gradient-based optimization method. For character information, the server encodes the text into a sequence of tokens, maps the tokens to embeddings, and inputs the embeddings into a transformer-based encoder. The encoder outputs a vector representation of the text, which is fed into a classification layer to obtain emotion feature information.

The server stores emotion feature information as a vector of scores or as a set of labels with associated intensities. By representing emotion as quantitative feature information, the server can control multiple downstream processes in a unified manner. For example, the server uses the emotion feature information to determine both the tone instructions in a prompt sentence and prosody parameters in a speech synthesis process. This coupling of representation allows the server to perform consistent emotion-aware control across text generation and audio synthesis, which reduces mismatches between textual tone and vocal prosody and therefore reduces perceived unnaturalness in the final output.

The server acquires related information corresponding to the content target by executing an information acquisition process. The server forms search queries using the extracted keywords, and transmits requests to external information sources via the network interface. External information sources include content repositories, search services, and structured databases. The server receives textual data such as article titles, summaries, and full texts. The server parses the received data by removing markup tags, normalizing character encodings, and detecting duplicate content by hash comparison or similarity computation based on vector representations. The server stores the cleaned and deduplicated related information in an information storage device, associated with identifiers linking the information to the corresponding user instruction information. Since the server filters and normalizes external data prior to generation, the server reduces the generative model's exposure to noise and redundancy, which improves the accuracy and stability of subsequent content generation and reduces the number of model calls required to obtain acceptable output.

The server constructs a prompt sentence for a generative information processing model by combining multiple elements: the normalized content target, the delivery time, the emotional state, structural instructions, and summaries of the related information. The server calculates a target script length, for example by multiplying the delivery time by a nominal word-per-minute rate. The server then inserts a constraint into the prompt sentence such as “generate approximately N words so that the spoken duration is about T minutes.” The server also encodes structural constraints, for example “include an introduction, three main segments, and a conclusion,” and tone constraints, for example “use a calm and relaxing tone” or “use an energetic and inspiring tone.”

The server forms the prompt sentence as a text string. Examples of prompt sentences are as follows:
“You are a scriptwriter for an audio program. Create a script for a 30-minute radio program about the latest science and technology. The listener feels excited and wants an energetic, inspiring tone. Use the following information as source material: [summaries of collected articles]. Structure the program into an introduction, three main segments, and a closing. Use engaging but clear language suitable for a general audience, and generate roughly 4500-5000 words so that the spoken duration is about 30 minutes.”
“Create a 20-minute podcast script that provides technology tips to enhance focus and concentration. The listener wants to focus, so use a calm, clear, and motivating tone. Provide practical advice and examples, and generate a length suitable for about 20 minutes of spoken audio.”
“Generate a 30-minute radio show script about health and wellness. The listener wants to relax. Use a gentle and reassuring tone, include stress-relief tips, breathing exercises, and simple explanations of health topics based on the following information: [summaries]. Ensure that the script will take about 30 minutes to read aloud at a natural speaking speed.”

The server inputs the prompt sentence into a generative AI model implemented as a neural network with a transformer architecture. The model comprises an embedding layer, multiple self-attention layers, and feedforward layers. The model parameters have been trained in advance on large corpora of text by a language modeling objective that minimizes a prediction error for next tokens. The server tokenizes the prompt sentence into subword units, converts the tokens into numerical identifiers, and feeds the identifiers into the model. The model outputs a sequence of token probabilities, from which the server samples or selects tokens according to a decoding strategy such as temperature-controlled sampling or nucleus sampling. The server assembles the selected tokens into script data for audio.

The server applies a text editing process to the script data for audio. The server estimates the speaking time of the script by counting tokens or words and dividing by an assumed speaking speed. If the estimated duration exceeds the delivery time, the server executes a summarization process. In one embodiment, the server segments the script into logical paragraphs or sections, encodes each section using a text encoder, and ranks the sections by an importance score derived from attention weights or similarity to the content target. The server removes or compresses low-importance sections to reduce the length while preserving key information. If the estimated duration is shorter than the delivery time, the server performs an addition process. The server identifies sections that can be expanded, generates supplementary paragraphs by providing the generative AI model with partial context and explicit instructions such as “add more examples to explain this point,” and appends the additional content. This feedback-based editing loop allows the server to converge on a script length that closely matches the desired delivery time, reducing the need for manual adjustment and improving temporal accuracy.

The server also refines the writing style according to the emotional state. The server may invoke the generative model again with a prompt that instructs rewriting of the existing script while preserving factual content, for example “rewrite the following script to use a calm and relaxing tone” or “rewrite the following script to sound enthusiastic and encouraging.” The server supplies the current script as part of the input and receives a revised script. The server optionally validates that the revised script still satisfies the length constraints. By encoding tone instructions as explicit text constraints and reusing the model in a controlled manner, the server obtains stylistic adaptation that is difficult to implement by simple rule-based phrase replacement, thereby improving the consistency between the user's emotional state and the narrative style.

The server converts the final script data for audio into audio data by executing a speech synthesis process. The speech synthesis process is implemented by a text-to-speech engine that contains at least one acoustic model and one vocoder model. The acoustic model maps textual input into intermediate representations such as spectrograms, and the vocoder model maps spectrograms into waveforms. The server encodes the script into phonemes or grapheme sequences and aligns the sequences with prosody control parameters derived from the emotional state. For example, for a relaxed emotional state, the server assigns a slower speaking speed parameter, longer pause durations at section boundaries, and reduced pitch variation; for an excited emotional state, the server assigns a faster speaking speed and higher pitch variation.

The server then feeds the textual and prosody control information into the acoustic model. The acoustic model is trained by minimizing a reconstruction loss between predicted and ground-truth spectrograms using a gradient-based optimization procedure over a training corpus of human speech. The vocoder model is trained to generate audio waveforms minimizing a perceptual loss or adversarial loss. The server executes these models on the processor, optionally using a hardware accelerator. The resulting waveforms are encoded as audio data in a compressed format suitable for streaming. By integrating emotion feature information into the control parameters of the speech synthesis process, the server achieves a consistent and technically controlled mapping from high-level emotional labels to low-level waveform characteristics, leading to improved naturalness and perceived personalization, and reducing artifacts compared to simple pitch or speed scaling post-processing.

The server transmits the generated audio data to the terminal as an audio stream. The server may segment the audio data into chunks representing program configuration elements such as an introduction, each main segment, and a closing. The server uses a streaming protocol such as HTTP streaming or another real-time media protocol, and maintains a buffer of upcoming segments. In a variant, the server generates and synthesizes each segment incrementally and begins streaming the first segment before subsequent segments are fully computed. In this case, the server synchronizes generation and transmission, and the terminal begins playback with minimal startup delay. The overlapping of generation and consumption, coupled with segment-wise control of the generative AI model, reduces end-to-end latency and improves responsiveness for users requesting on-demand content close to the time of listening.

The terminal receives the audio stream and decodes the audio data using an audio playback module. The terminal outputs sound through a speaker or a connected audio device. In some embodiments, the terminal displays additional information such as the current segment title or remaining time, derived from metadata transmitted by the server. The user listens to the personalized audio program that has a duration tailored to the specified delivery time, a topic matching the content target, and a tone that corresponds to the user's emotional state.

The technical effect of the described configuration is that the server not only automates human authoring and narration, but also modifies and coordinates internal computational processes in ways that improve computer operation. The server reduces unnecessary calls to the generative model by selecting and summarizing external information before prompt generation; it constrains the model using explicit prompt sentences that encode delivery time and emotion, thereby decreasing the variance of generated output and the number of regeneration attempts. It adjusts length automatically by structured editing rather than manual trimming. It controls the speech synthesis engine at a parameter level based on emotion feature information, improving prosodic accuracy and reducing error in meeting timing constraints. These machine-internal improvements yield lower processing time, lower network load due to reduced re-transmissions, and more consistent adherence to temporal and tonal constraints, which constitute improvements in processing speed, resource utilization, and accuracy within the computing system itself.

Alternative embodiments may use different generative model architectures, such as recurrent neural networks or hybrid transformer-convolutional networks, and may employ alternative loss functions or optimization strategies for training. The server may employ different sentiment and emotion analysis models, such as support vector machines or ensemble classifiers, instead of neural networks. The speech synthesis process may use alternative acoustic features or vocoder designs. The server may further integrate caching mechanisms for frequently requested content targets and delivery times, which reduces repeated external information acquisition and prompt construction, thereby decreasing network traffic and computational cost. In all such variations, the essential feature is that the server forms a prompt sentence including control conditions derived from user instruction information, controls a generative AI model and a speech synthesis process in accordance with those control conditions, and provides audio content to a terminal as a time-constrained, emotion-adaptive audio stream.

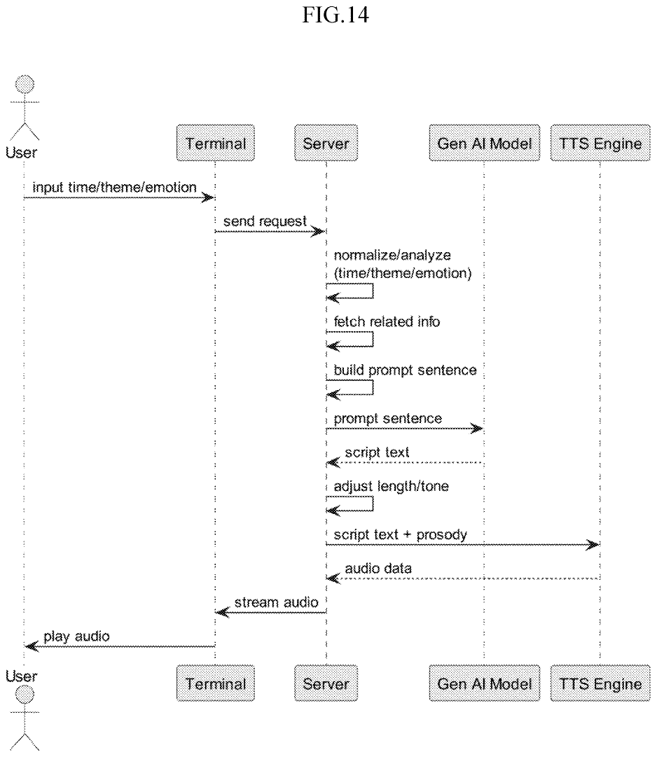

The following describes the processing flow using FIG. 14.

### Step 1:

User operates the terminal to specify requirements.

User launches an application on the terminal and inputs a delivery time (for example, “30 minutes”), a content target (for example, “latest science and technology”), and an emotional state (for example, “I want to relax” or “I am excited”). User optionally records voice to express mood or additional preferences.

Input: Human operations and spoken utterances.

Output: Raw input data on the terminal, including numerical time values, text strings, and optional audio signals.

### Step 2:

Terminal formats and transmits user instruction information.

Terminal converts any voice input into text using a speech recognition function. Terminal validates that the delivery time is a valid number and that the content target string is not empty. Terminal constructs user instruction information as a structured data record including at least the delivery time, the content target, and the emotional state (text and/or transcribed voice). Terminal sends this data record to the server via a network protocol such as HTTPS.

Input: Raw input data containing delivery time, content target, emotional state text, and optional audio.

Output: Structured user instruction information transmitted to the server as a data record.

### Step 3:

Server stores and normalizes the user instruction information.

Server receives the structured user instruction information and stores it in a database record with a unique identifier. Server converts the delivery time into a normalized numeric value (for example, minutes as a floating-point number), normalizes character encodings for text fields, and removes control characters and extra whitespace.

Input: Structured user instruction information received over the network.

Output: Normalized and stored instruction record containing cleaned text fields and normalized time values.

### Step 4:

Server extracts topic features from the content target.

Server tokenizes the content target text using a natural language processing library. Server removes stop words and identifies important terms such as nouns and noun phrases. Server converts the identified terms into numerical identifiers and aggregates them into a topic feature vector.

Input: Normalized content target string from the instruction record.

Output: Topic feature vector and a list of key terms representing the content target.

### Step 5:

Server determines the emotional state label and emotion feature information.

Server examines the emotional state text and any additional character information. Server applies a rule-based mapping or sends the text to an emotion classification model to obtain probabilities for emotion categories such as “relax,” “excited,” or “focus.” Server selects the category with the highest probability as the emotional state label and stores the label and probability scores as emotion feature information.

Input: Emotional state text and optional additional character information.

Output: Emotional state label and numerical emotion feature information linked to the instruction record.

### Step 6:

Server analyzes voice information when provided.

Server checks whether the instruction record includes user voice data. If voice data is present, server converts the audio waveform into features such as Mel-spectrograms and inputs the features into a trained speech-emotion model. Server calculates probabilities for multiple emotion classes and combines these with existing emotion feature information.

Input: Voice data associated with the user instruction information.

Output: Updated emotion feature information that may refine or override the initial emotional state label.

### Step 7:

Server acquires related external information based on the topic features.

Server constructs one or more search queries from the topic feature vector and key terms. Server sends these queries to external information sources and receives responses including articles, summaries, and metadata. Server parses the responses, strips markup, and removes duplicate or low-relevance items by computing similarity scores between items and the topic feature vector.

Input: Topic feature vector and list of key terms.

Output: Cleaned and filtered related information set associated with the content target.

### Step 8:

Server summarizes and structures the related information for later use.

Server groups related information into sections such as “background,” “recent developments,” and “examples.” Server applies text summarization routines to long documents to reduce them to concise summaries while preserving important facts. Server stores the summarized segments as ordered text blocks, each with an internal label indicating its role.

Input: Cleaned related information set.

Output: Structured set of summary text blocks annotated with roles for later insertion into a prompt sentence.

### Step 9:

Server calculates a target script length from the delivery time.

Server multiplies the delivery time by an estimated words-per-minute value to compute a target word count. Server defines an acceptable range around this target to accommodate natural variation.

Input: Normalized delivery time value.

Output: Target script length and acceptable length range to be enforced in downstream processing.

### Step 10:

Server constructs a prompt sentence for the generative AI model.

Server assembles the content target, emotional state label, structured summaries, and target script length into a single textual instruction. Server inserts explicit control clauses such as “generate approximately N words so that the spoken duration is about T minutes” and “use a calm and relaxing tone” or “use an energetic and inspiring tone.” Server also encodes structural requirements such as “include an introduction, three main segments, and a conclusion.”

Input: Content target, emotional state label, structured summary text blocks, and target script length.

Output: Prompt sentence as a continuous text string that encodes length, structure, and tone constraints for a generative AI model.

### Step 11:

Server submits the prompt sentence to the generative AI model and generates initial script data for audio.

Server tokenizes the prompt sentence into subword units and maps them to token identifiers.

Server forwards the token sequence to a generative AI model with a transformer architecture.

The model processes the tokens through multiple attention and feedforward layers and produces new tokens representing the script content. Server decodes the output tokens back into text.

Input: Prompt sentence text derived from control conditions and related information.

Output: Initial script data for audio in textual form, reflecting the constraints expressed in the prompt sentence.

### Step 12:

Server estimates the duration of the initial script and evaluates deviation from the target.

Server counts the words or tokens of the generated script and divides the count by the assumed words-per-minute rate to estimate speaking duration. Server compares the estimated duration with the target delivery time and records the amount and direction of deviation.

Input: Initial script data for audio and target script length or delivery time.

Output: Estimated speaking duration and a deviation value indicating whether the script is too long, too short, or within range.

### Step 13:

Server shortens the script when the estimated duration exceeds the delivery time.

Server identifies sections of the script with lower importance by computing similarity between each section and the topic feature vector and by checking whether the section repeats information already covered. Server either deletes selected sections or calls a summarization module to condense them into shorter forms. Server recomputes the estimated duration after each adjustment.

Input: Initial script data for audio and deviation indicating that duration is excessive.

Output: Reduced script data for audio whose estimated duration is closer to the delivery time.

### Step 14:

Server extends the script when the estimated duration is shorter than the delivery time.

Server selects sections that can be safely elaborated, such as example lists or explanation paragraphs. Server forms auxiliary prompt sentences that request expansions, for example “add more practical examples to this explanation” or “add another segment discussing future trends,” and passes the selected context to the generative AI model. Server appends or inserts the generated expansions and updates the duration estimate.

Input: Initial or shortened script data for audio and deviation indicating that duration is insufficient.

Output: Extended script data for audio whose estimated duration is brought into the acceptable range.

### Step 15:

Server adjusts the writing style of the script according to the emotional state.

Server checks the emotional state label and forms a style-adjustment instruction such as “rewrite this script to be calm and relaxing” or “rewrite this script to be enthusiastic and encouraging.” Server passes the current script and the style instruction to the generative AI model. Server receives a revised script and verifies that major factual elements and structure are preserved.

Input: Length-adjusted script data for audio and emotional state label.

Output: Style-adjusted script data for audio whose tone matches the emotional state.

### Step 16:

Server generates prosody control parameters from emotion feature information.

Server maps the emotion feature information to numerical parameters for speaking speed, pitch range, and pause duration. For example, server assigns a lower speaking speed and longer pauses for a relaxed emotional state, and a higher speaking speed and greater pitch variation for an excited emotional state. Server stores these parameters in association with the corresponding script segments.

Input: Emotion feature information and final script structure.

Output: Prosody control parameter set specifying how each segment should be spoken.

### Step 17:

Server converts the final script segments into acoustic features.

Server splits the script data into segments such as introduction, main segments, and conclusion. Server encodes each segment into phoneme or grapheme sequences and aligns them with the prosody control parameters. Server feeds the aligned sequences into an acoustic model that computes intermediate acoustic representations such as spectrogram frames.

Input: Final script segments and prosody control parameters.

Output: Acoustic feature sequences for each segment that incorporate both textual content and prosody control.

### Step 18:

Server synthesizes audio waveforms from acoustic features.

Server passes the acoustic feature sequences to a vocoder model that generates digital audio waveforms. Server encodes the waveforms into a selected audio format and may normalize volume levels and remove artifacts using signal processing routines.

Input: Acoustic feature sequences generated from script segments.

Output: Encoded audio data for each segment, ready for streaming or concatenation.

### Step 19:

Server assembles segment audio data into a complete audio program.

Server orders the segment audio files according to the program structure and concatenates them into a continuous sequence, optionally inserting transitional sounds or short silences at segment boundaries. Server measures the total duration and verifies alignment with the delivery time.

Input: Encoded audio data for individual segments and program structure metadata.

Output: A complete audio program as a continuous audio file or as an ordered list of audio segments.

### Step 20:

Server prepares audio data for streaming distribution.

Server segments the audio program into network-friendly chunks or prepares a streaming playlist depending on the chosen streaming protocol. Server generates a streaming identifier or URL that the terminal can use to request the stream.

Input: Complete audio program data and chosen streaming protocol settings.

Output: Streamable audio representation and an associated streaming access identifier.

### Step 21:

Server initiates transmission of audio data in synchronization with the delivery time.

Server schedules or immediately begins sending audio chunks to the terminal according to the requested delivery time and playback start conditions. Server controls the rate of transmission to match the expected playback rate and monitors network conditions to adjust buffer sizes.

Input: Streamable audio representation, streaming access identifier, and requested delivery time.

Output: Sequence of audio data packets sent over the network toward the terminal.

### Step 22:

Terminal receives and buffers the streaming audio data.

Terminal opens a network connection using the streaming access identifier and starts receiving audio packets. Terminal writes the packets into a playback buffer and decodes them into raw audio frames.

Input: Sequence of audio data packets received from the server.

Output: Buffered and decoded audio frames stored locally on the terminal for imminent playback.

### Step 23:

Terminal reproduces the audio program for the user.

Terminal reads decoded audio frames from the buffer and sends them to a digital-to-analog converter connected to a speaker or headset. Terminal maintains continuous playback as long as sufficient buffered data is available.

Input: Buffered and decoded audio frames.

Output: Audible sound reproducing an audio program that matches the user's specified delivery time, content target, and emotional state.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

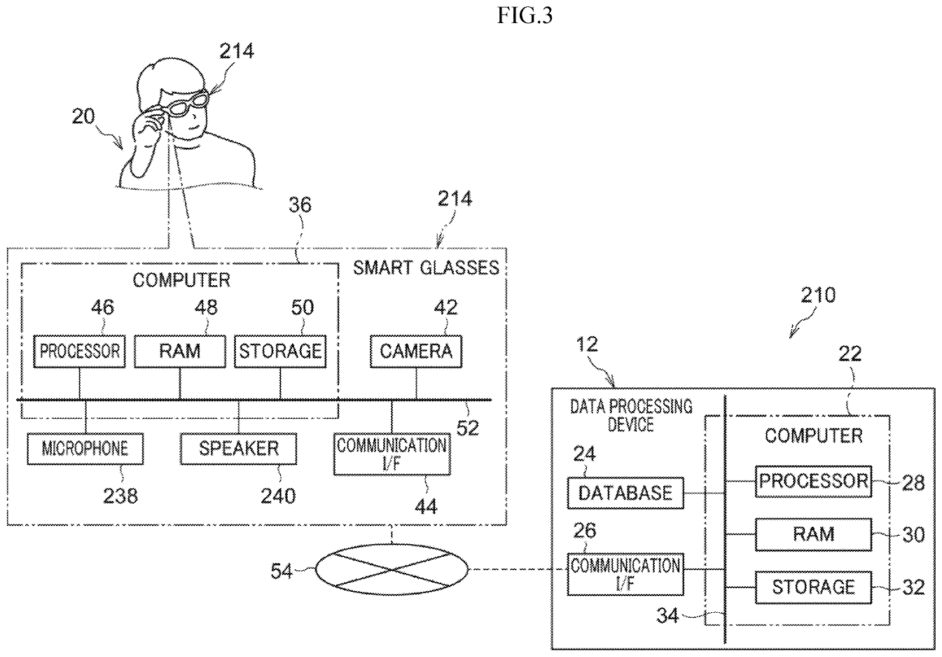

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

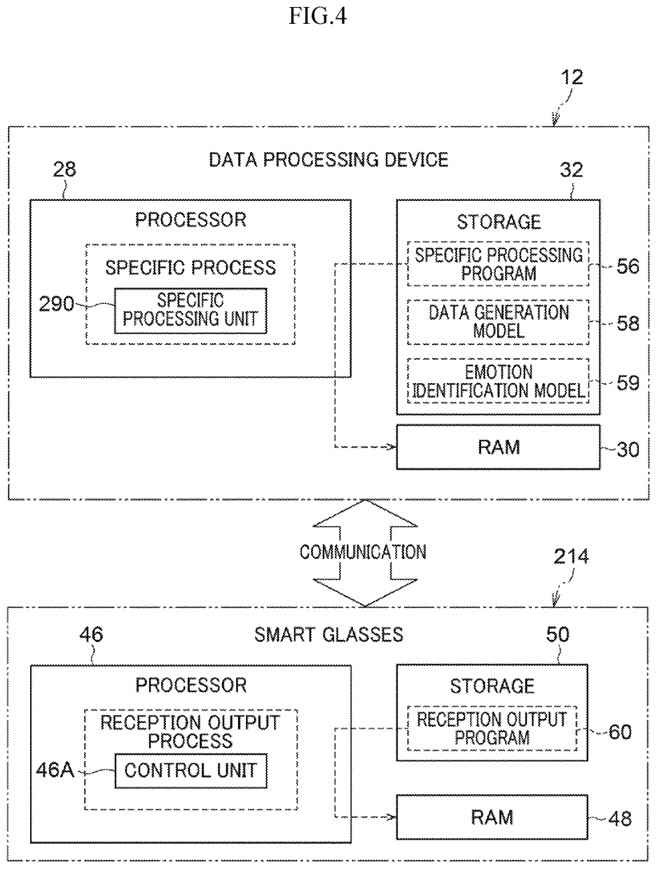

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

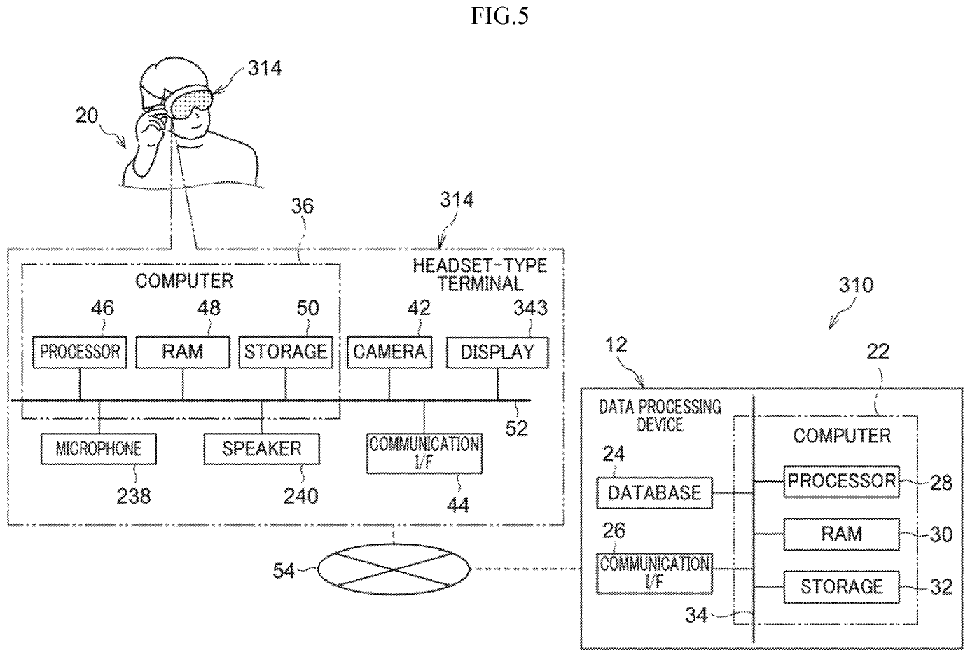

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

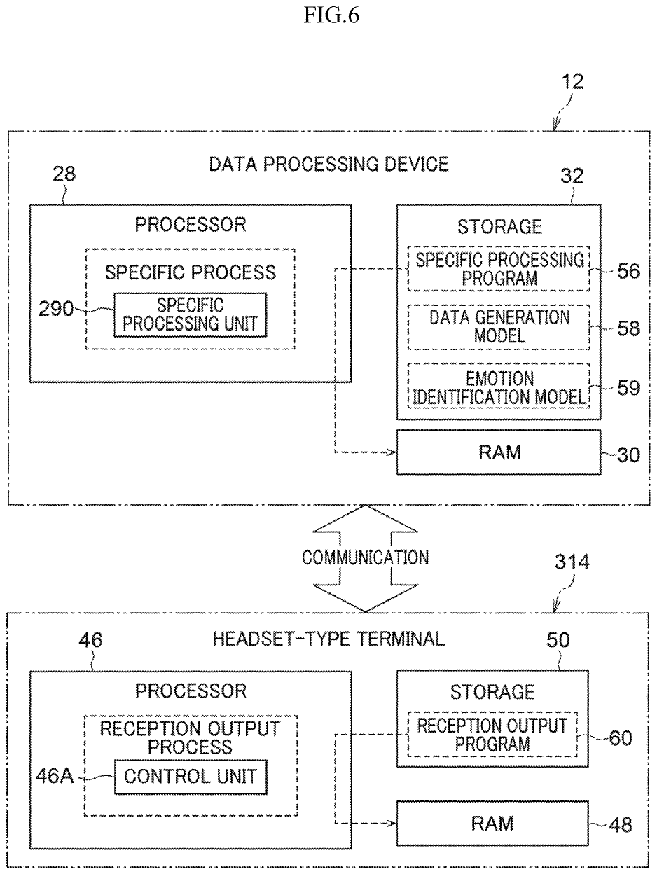

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

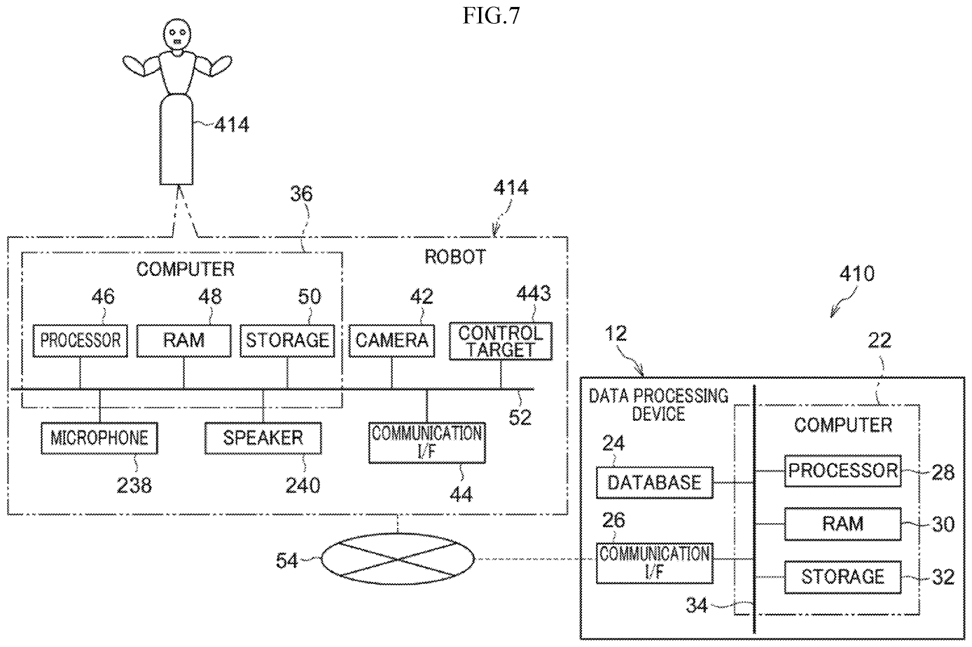

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

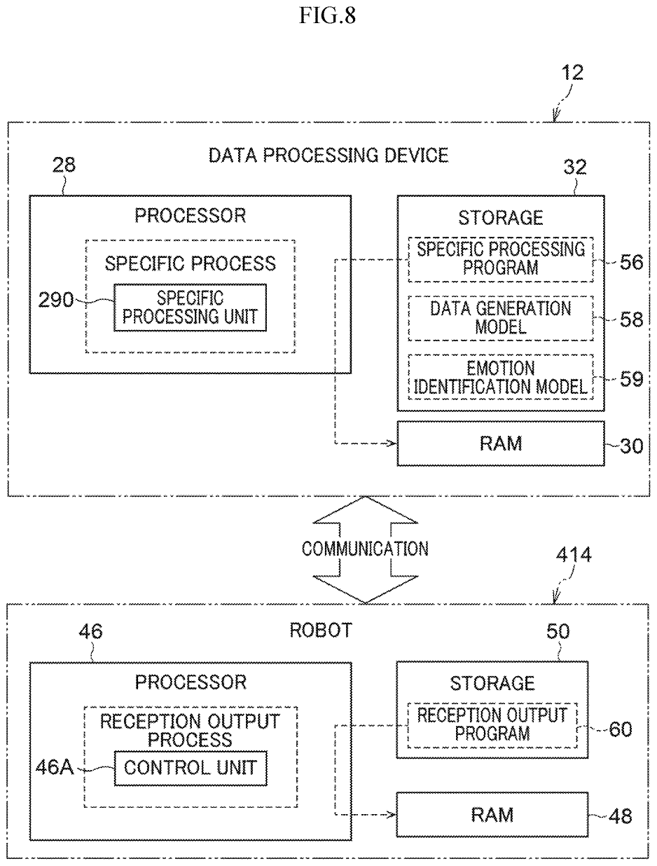

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

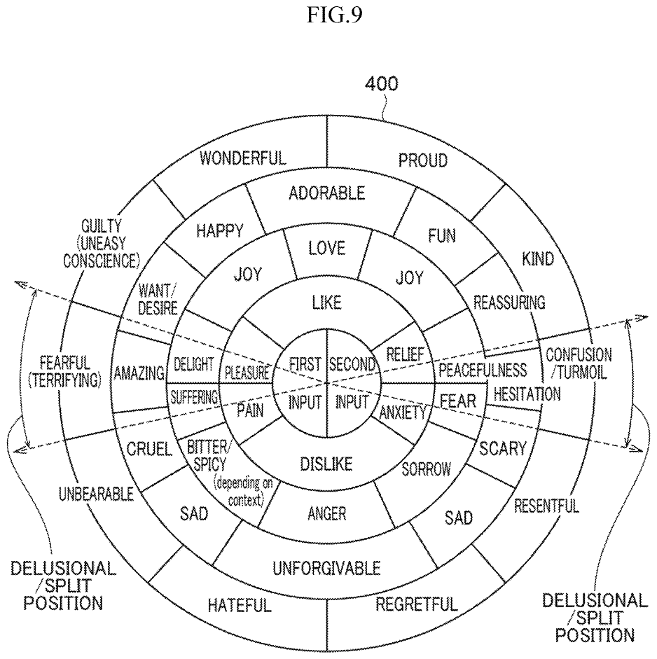

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

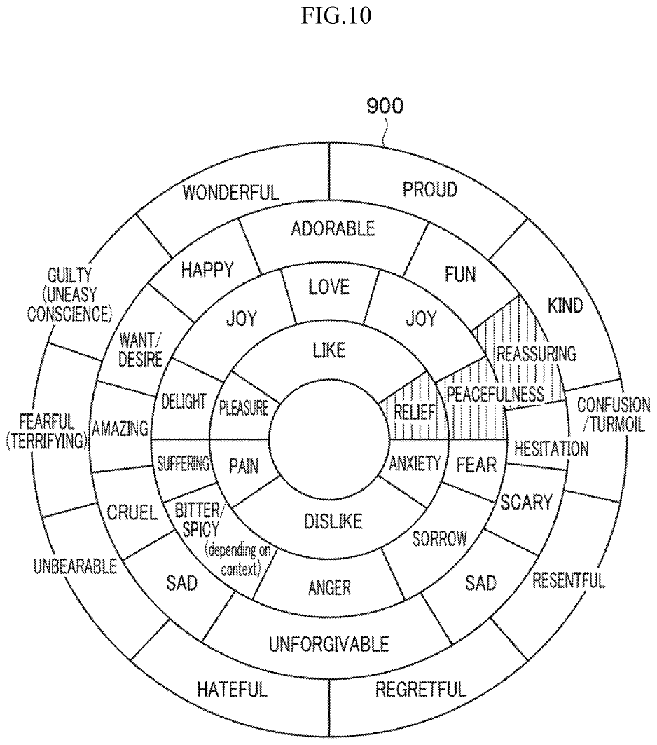

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to receive delivery time information and theme information from a user terminal, and generate a prompt sentence including a program structure corresponding to the delivery time information and a content structure corresponding to the theme information, based on the delivery time information and the theme information,
input the prompt sentence to a generative artificial intelligence model, instruct the generative artificial intelligence model to generate program text information based on the prompt sentence, and acquire the program text information output from the generative artificial intelligence model,
calculate a playback time for the program text information based on an assumed speech rate, compare the playback time with the delivery time information, and adjust an amount of the program text information so that the playback time matches or approximates the delivery time information, and
input the adjusted program text information to a speech synthesis processing unit, instruct the speech synthesis processing unit to generate audio data corresponding to the program text information, convert the audio data into a streaming delivery format, and provide the audio data in the streaming delivery format to the user terminal.

### (Supplementary 2)

The system according to supplementary 1,
wherein the processor is configured to
generate the prompt sentence by combining the delivery time information and the theme information with template information including tone information and configuration information of a program, and explicitly specify, in the prompt sentence, a program format including an introduction part, a plurality of segment parts, and a closing part.

### (Supplementary 3)

The system according to supplementary 1,
wherein the processor is configured to
generate an additional input prompt sentence for the generative artificial intelligence model, instruct the generative artificial intelligence model to generate additional text information based on the additional input prompt sentence when the program text information is insufficient relative to the delivery time information, and perform partial deletion or summarization of the program text information when the program text information is excessive relative to the delivery time information, thereby adjusting the amount of the program text information.

### Application Example 1

### (Supplementary 1)

A system comprising a processor,
wherein the processor is configured to
receive, from a terminal, information including a delivery time and a theme, calculate a target length for audio output based on the delivery time and generate a prompt sentence by combining the theme and the target length, and input the prompt sentence to a generative AI model so as to cause the generative AI model to generate text information for audio content,
input the text information for the audio content to a speech synthesis unit so as to convert the text information into audio data, store the audio data in a storage unit, and provide the audio data to the terminal in a format enabling streaming or downloading,
store identification information and delivery management information related to the text information for the audio content and the audio data in a memory unit, and
in response to a playback instruction from the terminal, read out the audio data from the storage unit and transmit the audio data to the terminal.

### (Supplementary 2)

The system according to supplementary 1,
wherein the processor is configured to
estimate a number of words or a number of tokens required for the audio output based on the theme and the delivery time, and add a description including the estimated number to the prompt sentence so as to control a length of the text information for the audio content generated by the generative AI model.

### (Supplementary 3)

The system according to supplementary 1,
wherein the processor is configured to
determine that a length of the text information acquired from the generative AI model is outside a predetermined range with respect to the target length, generate an additional prompt sentence corresponding to content of the text information, and input the additional prompt sentence to the generative AI model again so as to complement or edit the text information and adjust the text information for the audio content toward the target length.

### Example 2

### (Supplementary 1)

A system comprising a processor,
wherein the processor is configured to
receive, from a user terminal, distribution time information, topic information, and emotion information specified by a user,
acquire, based on the topic information, related information from an information providing service via a communication network, and store the acquired related information as a structured information set in a storage device,
calculate a target content length from the distribution time information, and generate a prompt sentence to be input to a generative AI model, the prompt sentence including the topic information, the emotion information, the target content length, and at least part of the structured information set as an instruction sentence for causing the generative AI model to generate audio content,
input the prompt sentence into the generative AI model and cause the generative AI model to generate an audio content script based on the structured information set,
and generate audio data by using a speech synthesis technique based on the audio content script and provide the audio data to the user terminal.

### (Supplementary 2)

The system according to supplementary 1,
wherein the processor is configured to
receive, from the user terminal, an edited script obtained by allowing the user to edit the audio content script on the user terminal, generate the audio data based on the edited script,
store the edited script and the audio data in association with the distribution time information, and control distribution of the audio data in accordance with the distribution time information.

### (Supplementary 3)

The system according to supplementary 1,
wherein the processor is configured to
provide the audio content script to the user terminal in a form viewable by the user, receive, from the user terminal or an external recording device, audio content corresponding to an edited version of the audio content script, and make the received audio content distributable based on the distribution time information.

### Application Example 2

### (Supplementary 1)

A system comprising a processor,
wherein the processor is configured to
receive user instruction information from a user terminal, the user instruction information including a delivery time designated by a user, a content target, and an emotional state,
perform, on the basis of the content target and the emotional state included in the user instruction information, an information acquisition process to collect related information from a communication network or an information storage device, and generate a prompt sentence for a generative information processing model, the prompt sentence instructing the generative information processing model to generate script data for audio, the prompt sentence being generated on the basis of the related information and control conditions including the delivery time and the emotional state,
input the prompt sentence into the generative information processing model and adjust script data for audio generated by the generative information processing model by performing a text editing process including a summarization process or an addition process so that the script data has a length and a writing style corresponding to the delivery time and the emotional state,
input the adjusted script data for audio into a speech synthesis process and generate audio data by controlling audio output characteristics including speaking speed, prosody, and voice quality in accordance with the emotional state, and
sequentially transmit the generated audio data to the user terminal in synchronization with the delivery time and provide the audio data as an audio stream capable of continuous reproduction.

### (Supplementary 2)

The system according to supplementary 1,
wherein the processor is configured to
sequentially input the prompt sentence into the generative information processing model in a stepwise manner, sequentially generate the script data for audio from the generative information processing model in units of a plurality of program configuration elements,
execute the speech synthesis process each time to generate partial audio data, and perform real-time audio distribution by transmitting the partial audio data to the user terminal in real time.

### (Supplementary 3)

The system according to supplementary 1,
wherein the processor is configured to
when the emotional state is determined on the basis of voice information or character information from the user, use an emotion analysis process to extract emotion feature information from the voice information or the character information, and modify tone instructions and program structure instructions included in the prompt sentence in accordance with the emotion feature information so that content and atmosphere of the script data for audio generated by the generative information processing model are adapted to the emotional state of the user.

What is claimed is:

1. A system comprising:
circuitry configured to:
receive, via a communication interface coupled to a packet-switched network, user instruction information from a terminal device, the user instruction information including a delivery time, a theme, and an emotion specified by a user;
generate a prompt sentence for instructing a generative AI model to generate audio content based on the received delivery time, theme, and emotion;
cause the generative AI model to generate the audio content using the prompt sentence; and
convert the generated audio content into audio data using a speech synthesis technique and transmit the audio data to the terminal device via the communication interface.

2. The system according to claim 1, wherein the circuitry is configured to generate, based on the delivery time, a prompt sentence including a program structure corresponding to the delivery time and a content structure corresponding to the theme, and input the prompt sentence to the generative AI model to cause the generative AI model to generate program text information based on the prompt sentence.

3. The system according to claim 2, wherein the circuitry is configured to calculate a playback time for the program text information based on an assumed speech rate, compare the playback time with the delivery time, and adjust an amount of the program text information so that the playback time matches or approximates the delivery time.

4. The system according to claim 3, wherein the circuitry is configured to generate an additional prompt sentence to cause the generative AI model to generate additional text information when the program text information is insufficient relative to the delivery time, and perform partial deletion or summarization of the program text information when the program text information is excessive relative to the delivery time.

5. The system according to claim 1, wherein the circuitry is configured to collect related information from one or more information providing services via the communication interface based on the theme and the emotion, store the collected related information as a structured information set in a storage device, and generate the prompt sentence based on the structured information set.

6. The system according to claim 5, wherein the circuitry is configured to calculate a target content length from the delivery time, and generate the prompt sentence including the theme, the emotion, the target content length, and at least part of the structured information set as an instruction for the generative AI model.

7. The system according to claim 6, wherein the circuitry is configured to provide an audio content script generated by the generative AI model to the terminal device for review, receive an edited script from the terminal device, and generate the audio data based on the edited script.

8. The system according to claim 1, wherein the circuitry is configured to control audio output characteristics including speaking speed, prosody, and voice quality of the speech synthesis technique in accordance with the emotion specified by the user.

9. The system according to claim 8, wherein the circuitry is configured to adjust script data generated by the generative AI model by performing a text editing process including a summarization process or an addition process so that the script data has a length and a writing style corresponding to the delivery time and the emotion.

10. The system according to claim 9, wherein the circuitry is configured to sequentially transmit the generated audio data to the terminal device in synchronization with the delivery time so as to provide the audio data as an audio stream capable of continuous reproduction.

11. The system according to claim 1, wherein the circuitry is configured to estimate, based on the delivery time and the theme, a number of words or tokens required for the audio output, incorporate the estimate into the prompt sentence, and iteratively adjust the program text information by supplying additional prompt sentences to the generative AI model when a length of the generated text information deviates from a target length.

12. The system according to claim 1, wherein the circuitry is configured to store audio data and associated identification information and delivery management information in a storage device, and, in response to a playback instruction received from the terminal device via the communication interface, read out the audio data from the storage device and transmit the audio data to the terminal device.

13. The system according to claim 1, wherein the circuitry is configured to perform language detection on the received user instruction information, apply machine translation when the user instruction information is not in a target processing language, and normalize the user instruction information prior to generating the prompt sentence.

14. The system according to claim 1, wherein the circuitry is configured to receive, from the terminal device, voice information or character information expressing preferences of the user in addition to the delivery time, the theme, and the emotion, and incorporate the preferences into the prompt sentence.

15. The system according to claim 1, wherein the circuitry is configured to store the audio data in a storage device in association with the delivery time, and control distribution of the audio data in accordance with the delivery time.

16. The system according to claim 1, wherein the circuitry is configured to generate a program structure for the audio content including an introduction part, one or more segment parts, and a closing part based on the delivery time, and incorporate the program structure into the prompt sentence.

17. The system according to claim 16, wherein the circuitry is configured to assign a target word count or token count to each part of the program structure based on the delivery time, and instruct the generative AI model to generate text conforming to the assigned word count or token count for each part.

18. A system comprising:
circuitry configured to:
receive, via a communication interface coupled to a packet-switched network, user instruction information from a terminal device, the user instruction information including a delivery time, a theme, and an emotion specified by a user;
calculate a target content length from the delivery time, collect related information from one or more information providing services via the communication interface based on the theme, and generate a prompt sentence incorporating the target content length, the theme, the emotion, and the collected related information;
input the prompt sentence to a generative AI model and obtain program text information generated by the generative AI model, and adjust an amount of the program text information so that a playback time calculated based on an assumed speech rate matches or approximates the delivery time; and
convert the adjusted program text information into audio data using a speech synthesis technique and transmit the audio data to the terminal device via the communication interface.

19. The system according to claim 18, wherein the circuitry is configured to control audio output characteristics including speaking speed, prosody, and voice quality of the speech synthesis technique in accordance with the emotion specified by the user.

20. A method comprising:
receiving, via a communication interface coupled to a packet-switched network, user instruction information from a terminal device, the user instruction information including a delivery time, a theme, and an emotion specified by a user;
generating a prompt sentence for instructing a generative AI model to generate audio content based on the received delivery time, theme, and emotion;
causing the generative AI model to generate the audio content using the prompt sentence; and
converting the generated audio content into audio data using a speech synthesis technique and transmitting the audio data to the terminal device via the communication interface.
